(19) United States
(12) Patent Application Publication
(10) Pub. No.: US 2025/0203331 A1
(43) Pub. Date: Jun. 19, 2025

(54) IN-VEHICLE COMMUNICATION SYSTEM AND COMMUNICATION NODE

(71) Applicant: DENSO CORPORATION, Kariya-city (JP)

(72) Inventors: Daisuke KOBAYASHI, Kariya-city (JP); Hironori Shirai, Kariya-city (JP); Takahiro Sasaki, Kariya-city (JP)

(21) Appl. No.: 19/063,852

(22) Filed: Feb. 26, 2025

Related U.S. Application Data
(63) Continuation of application No. PCT/JP2023/033067, filed on Sep. 11, 2023.

(30) Foreign Application Priority Data
Sep. 14, 2022 (JP) 2022-146307

(51) Int. Cl. H04W 4/48; H04W 52/02

(52) U.S. Cl. CPC H04W 4/48; H04W 52/0235

(57) ABSTRACT

An in-vehicle communication system includes a first node and a second node configured to perform communication with the first node via a first communication line in accordance with a predetermined communication standard. The first node is configured to activate the first node in response to occurrence of an activation factor in the first node in a sleep state, transmit an activation request signal to the second node, and transmit the activation request signal to the second node via the first communication line when a transmission condition is satisfied with the second node. The second node is configured to be activated upon receiving the activation request signal from the first communication line while the second node is in the sleep state.

### CROSS REFERENCE TO RELATED APPLICATION

The present application is a continuation application of International Patent Application No. PCT/JP2023/033067 filed on Sep. 11, 2023 which designated the U.S. and claims the benefit of priority from Japanese Patent Application No. 2022-146307 filed on Sep. 14, 2022. The entire disclosures of all of the above applications are incorporated herein by reference.

### TECHNICAL FIELD

The present disclosure relates to a technique for wired communication between a plurality of nodes in a vehicle.

### BACKGROUND

A related art discloses an in-vehicle network including a plurality of electronic control units (ECUs). In this in-vehicle network, an ECU in a sleep state wakes up when a condition for waking up is satisfied.

### SUMMARY

An in-vehicle communication system includes a first node and a second node configured to perform communication with the first node via a first communication line in accordance with a predetermined communication standard. The first node is configured to activate the first node in response to occurrence of an activation factor in the first node in a sleep state, the activation factor being not caused by the communication, transmit an activation request signal to the second node via the first communication line in response to activation of the first node by the activation section, and transmit the activation request signal to the second node via the first communication line when a transmission condition is satisfied with the second node, the transmission condition corresponding to a condition under which the activation request signal is to be transmitted. The second node is configured to be activated upon receiving the activation request signal from the first communication line while the second node is in the sleep state.

### BRIEF DESCRIPTION OF DRAWINGS

Objects, features and advantages of the present disclosure will become more apparent from the following detailed description made with reference to the accompanying drawings. In the drawings:

FIG. 1 is an explanatory diagram illustrating an outline of an in-vehicle communication system according to a first embodiment;

FIG. 2 is a block diagram illustrating a specific configuration of the in-vehicle communication system according to the first embodiment;

FIG. 3 is an explanatory diagram illustrating a first operation example of the in-vehicle communication system according to the first embodiment;

FIG. 4 is an explanatory diagram illustrating a second operation example of the in-vehicle communication system according to the first embodiment;

FIG. 5 is an explanatory diagram illustrating a third operation example of the in-vehicle communication system according to the first embodiment;

FIG. 6 is a flowchart of a communication control process according to the first embodiment;

FIG. 7 is a flowchart of a retransmission control process according to the first embodiment;

FIG. 8 is a flowchart illustrating a first specific example (first pattern) of a retransmission process in the retransmission control process according to the first embodiment;

FIG. 9 is a flowchart illustrating a second specific example (second pattern) of the retransmission process in the retransmission control process according to the first embodiment;

FIG. 10 is a flowchart illustrating a third specific example (third pattern) of the retransmission process in the retransmission control process according to the first embodiment;

FIG. 11 is a flowchart of an another-node factor activation process according to the first embodiment;

FIG. 12 is a flowchart of a relay control process according to the first embodiment;

FIG. 13 is an explanatory diagram illustrating an outline of an in-vehicle communication system according to a second embodiment;

FIG. 14 is a block diagram illustrating a specific configuration of the in-vehicle communication system according to the second embodiment;

FIG. 15 is an explanatory diagram illustrating a first operation example of the in-vehicle communication system according to the second embodiment;

FIG. 16 is an explanatory diagram illustrating a part of the first operation example in FIG. 15 in more detail;

FIG. 17 is an explanatory diagram illustrating a second operation example of the in-vehicle communication system according to the second embodiment;

FIG. 18 is a flowchart of a communication control process according to the second embodiment;

FIG. 19 is a flowchart of a retransmission control process according to the second embodiment;

FIG. 20 is a flowchart illustrating a first specific example (first pattern) of a retransmission process in the retransmission control process according to the second embodiment;

FIG. 21 is a flowchart illustrating a second specific example (second pattern) of the retransmission process in the retransmission control process according to the second embodiment;

FIG. 22 is a flowchart illustrating a third specific example (third pattern) of the retransmission process in the retransmission control process according to the second embodiment;

FIG. 23 is a flowchart of an another-node factor activation process according to the second embodiment;

FIG. 24 is a flowchart of a relay control process according to the second embodiment;

FIG. 25 is a flowchart of a transfer setting control process according to the second embodiment; and

FIG. 26 is an explanatory diagram illustrating a modification of the in-vehicle communication system.

### DETAILED DESCRIPTION

In an in-vehicle network, for example, it is conceivable to adopt the following communication protocol. That is, a first node in the sleep state (i) requests a second node to wake up upon waking up due to an activation factor that occurred in the first node, and (ii) communicates with the second node that was woken up by the request. The first node corresponds to, for example, a first ECU. The second node corresponds to, for example, a second ECU different from the first ECU. As an example of such a communication protocol, so-called in-vehicle Ethernet (“Ethernet” is a registered trademark) is known.

As a result of detailed studies by the inventor, the following difficulties have been found in the communication specification as described above. That is, the second node, after being activated based on the wakeup request from the first node, can transition back to the sleep state due to an unexpected factor. The unexpected factor includes, for example, some anomaly or other factors in the second node performing communication. When the second node transitions to the sleep state due to such an unexpected factor, the first node cannot communicate with the second node. When the anomaly is removed from the second node that has transitioned to the sleep state, the second node can return to the normal state. However, in this case as well, since the second node is in the sleep state, the first node still cannot communicate with the second node.

The present disclosure provides an in-vehicle communication system in which, during communication between a first node and a second node, even if the second node unintentionally transitions to a sleep state node, a second node can be quickly woken up to return to communication with the first node.

An in-vehicle communication system according to one aspect of the present disclosure includes a first node and a second node. The second node is connected to the first node via a first communication line. The first node communicates with the second node via the first communication line. The communication follows a predetermined communication standard.

The first node includes an activation section, a first transmission section, and a second transmission section. The activation section activates the first node in response to occurrence of an activation factor in the first node in a sleep state. The activation factor is not caused by the communication. The first transmission section transmits an activation request signal to the second node via the first communication line in response to activation of the first node by the activation section. The second transmission section transmits the activation request signal to the second node via the first communication line when a transmission condition is satisfied with the second node. The transmission condition corresponds to a condition under which the activation request signal is to be transmitted.

The second node is activated upon receiving the activation request signal from the first communication line while the second node is in the sleep state.

In such an in-vehicle communication system, even if the second node unintentionally transitions to the sleep state due to some factor while the first node communicates with the second node activated by the first node, the second node can be quickly activated. This enables the second node to return to communication with the first node.

Hereinafter, exemplary embodiments of the present disclosure will be described with reference to the drawings.

### 1. First Embodiment

### (1-1) Outline of In-Vehicle Communication System

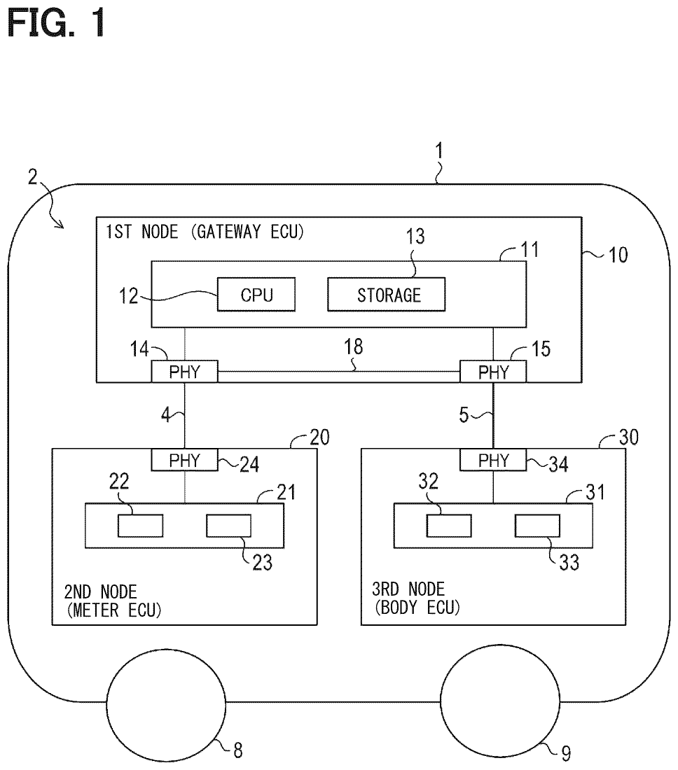

An in-vehicle communication system 2 illustrated in FIG. 1 is installed in a vehicle 1. The vehicle 1 includes a plurality of wheels including front wheels 8 and rear wheels 9. The vehicle 1 is, for example, in the form of a four-wheeled automobile.

The vehicle 1 includes a drive source (not illustrated) for causing the vehicle 1 to travel. The drive source may be configured in any manner. The drive source may include, for example, an internal combustion engine and/or an electric motor.

As illustrated in FIG. 1, the in-vehicle communication system 2 includes a first node 10, a second node 20, and a first communication line 4. The first communication line 4 communicably connects the first node 10 and the second node 20 to each other. That is, the first node 10 can communicate with the second node 20 via the first communication line 4.

In the in-vehicle communication system 2 of the present embodiment, communication between the first node 10 and the second node 20 is performed in accordance with a predetermined communication standard. In the present embodiment, the predetermined communication standard is in-vehicle Ethernet. The term “Ethernet” is a registered trademark. Ethernet is a known wired communication standard defined in IEEE802.3. It can be said that in-vehicle Ethernet is based on Ethernet, and Ethernet is partially modified in accordance with specifications required by the vehicle. In recent years, in-vehicle Ethernet has been standardized in the Institute of Electrical and Electronics Engineers (IEEE) and the OPEN (One-Pair Ether-Net) ALLIANCE.

The in-vehicle communication system 2 further includes a third node 30 and a second communication line 5. The second communication line 5 communicably connects the first node 10 and the third node 30 to each other. That is, the first node 10 can communicate with the third node 30 via the second communication line 5. In the in-vehicle communication system 2 of the present embodiment, communication between the first node 10 and the third node 30 is also performed in accordance with the predetermined communication standard described above.

Ethernet is a communication standard corresponding to Layer 1 (physical layer) and Layer 2 (data link layer) in the so-called Open Systems Interconnection (OSI) model. The function corresponding to Layer 2 includes (i) placing transmission data transferred from the upper layer on an Ethernet frame and transmitting the Ethernet frame to Layer 1, and (ii) restoring the reception data from the Ethernet frame received at Layer 1 and transferring the reception data to the upper layer. The upper layer includes, for example, an application layer, a presentation layer, a session layer, a transport layer, and a network layer. Functions corresponding to Layer 1 include (i) converting an Ethernet frame from Layer 2 into an electrical signal and transmitting the electrical signal, and (ii) converting a received electrical signal into an Ethernet frame and passing the Ethernet frame to Layer 2.

The Ethernet frame includes address information for each of a transmission source and a transmission destination. This address information is generally referred to as a MAC address. In the present embodiment, each of the first to third nodes 10 to 30 has unique address information. Each of the first to third nodes 10 to 30 includes its own address information in the Ethernet frame when transmitting data to another node.

The function corresponding to Layer 2 further includes an address identification function. The address identification function is implemented based on the transmission destination address included in the received Ethernet frame. Specifically, the address identification function discards the received Ethernet frame when the transmission destination address indicates a node different from the subject node. On the other hand, when the transmission destination address indicates the subject node, the address identification function passes the received Ethernet frame to the upper layer. When (i) a data relay function to be described later is provided, and (ii) the transmission destination address indicates another node connected to the subject node, the received Ethernet frame is transferred to that other node.

The vehicle 1 is equipped with a plurality of ECUs that control the vehicle 1. The term “ECU” is an abbreviation of an electronic control unit. In the present embodiment, as an example, each of the first to third nodes 10 to 30 corresponds to one of the plurality of ECUs.

The first node 10 is, for example, a gateway ECU. The first node 10 is connected to another communication system (not illustrated). The first node 10 controls transmission and reception of data between the other communication system and the in-vehicle communication system 2. A communication protocol used for communication between the other communication system and the gateway ECU differs from a communication protocol used in the in-vehicle communication system 2. In the communication between the other communication system and the gateway ECU, for example, CAN or CAN-FD may be used. The term “CAN” is an abbreviation for “Controller Area Network” and is a registered trademark. The term “CAN-FD” is an abbreviation for “Controller Area Network with Flexible Data rate” and is a registered trademark.

The second node 20 is, for example, a meter ECU. The meter ECU is responsible for controlling, for example, an instrument panel (not illustrated) provided in the vehicle 1.

The third node 30 is, for example, a body ECU. The body ECU is responsible for body system control in the vehicle 1. The body system control includes, for example, controlling (i) turning on/off of a light (not illustrated), (ii) locking/unlocking of a door (not illustrated), and/or (iii) vehicle theft prevention (unauthorized intrusion detection).

The first node 10 includes a control unit 11, a PHY 14, and a PHY 15. The term “PHY” is an abbreviation for “PHY ceiver”. The control unit 11 is connected to each of the PHY 14 and the PHY 15. The control unit 11 can transmit various signals and data to the other nodes and receive various signals and data from the other nodes through the PHY 14 and the PHY 15.

The control unit 11 implements various functions of the first node 10. The various functions include a function as the gateway ECU described above, a communication function with the second node 20 and the third node 30, and other functions.

The control unit 11 includes a central processing unit (CPU) 12 and a storage section 13. The storage section 13 includes, for example, semiconductor memory such as random-access memory (RAM), read-only memory (ROM), and flash memory. That is, the control unit 11 is mainly configured by a known microcomputer. Various functions of the control unit 11 are implemented by the CPU 12 executing a program stored in a non-transitory tangible recording medium. In the present example, the storage section 13 corresponds to the non-transitory tangible recording medium storing the program. When this program is executed, processing corresponding to the program is executed. The number of microcomputers constituting the control unit 11 may be one or more.

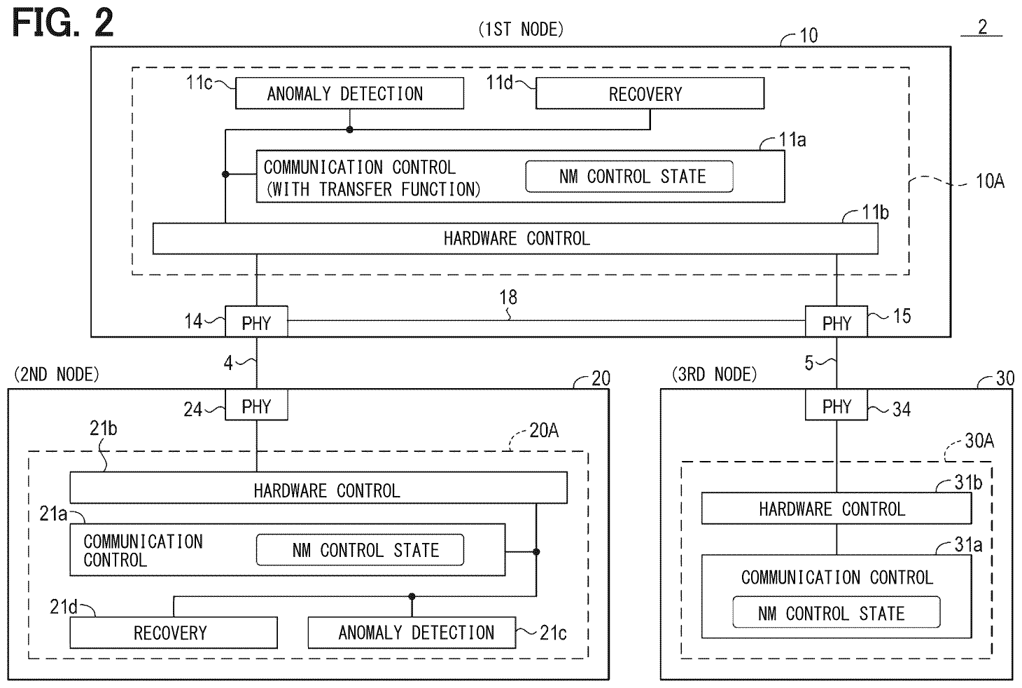

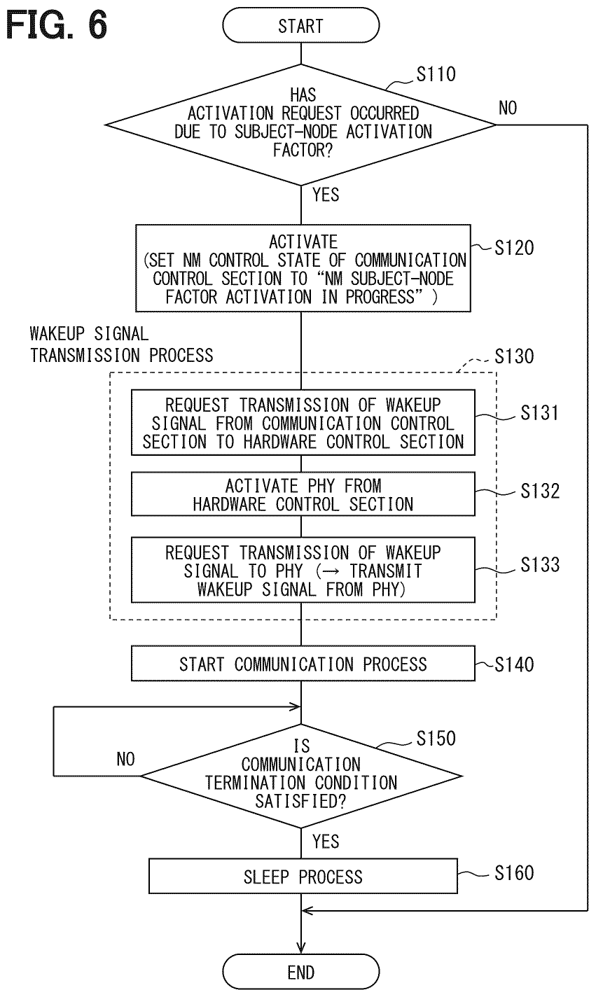

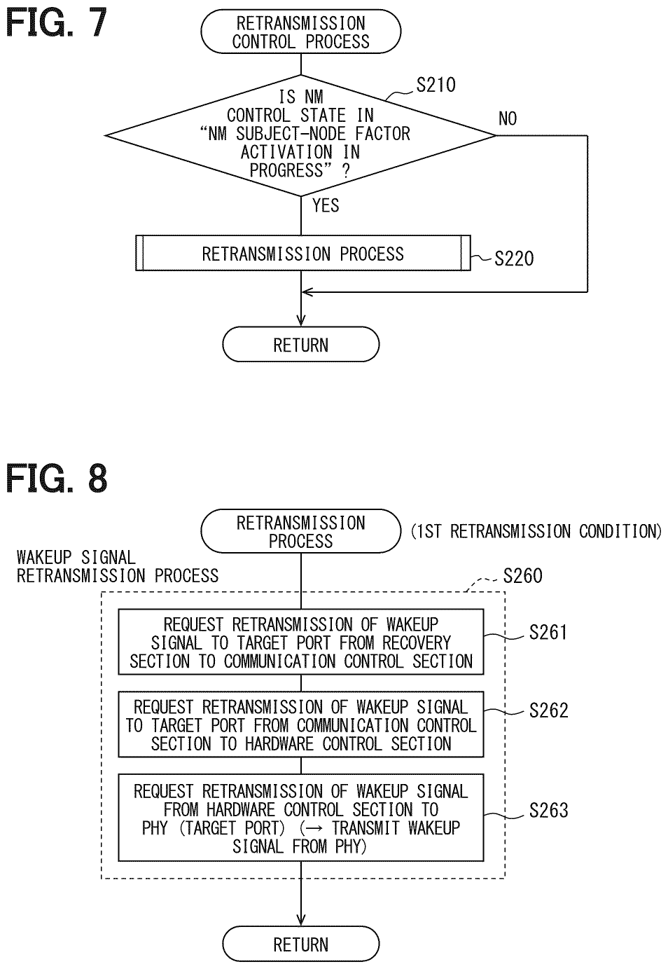

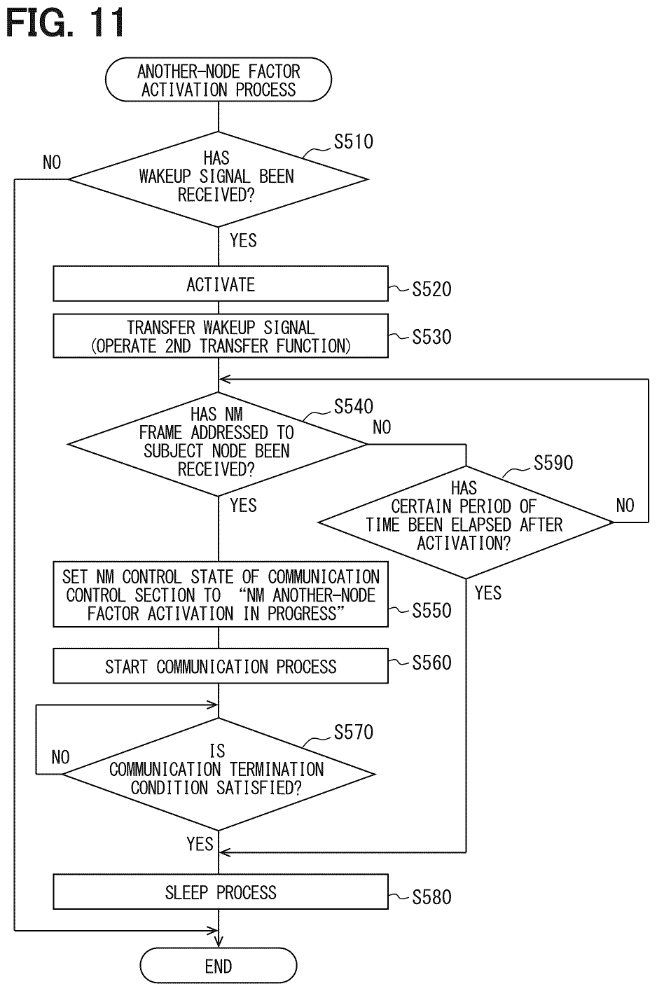

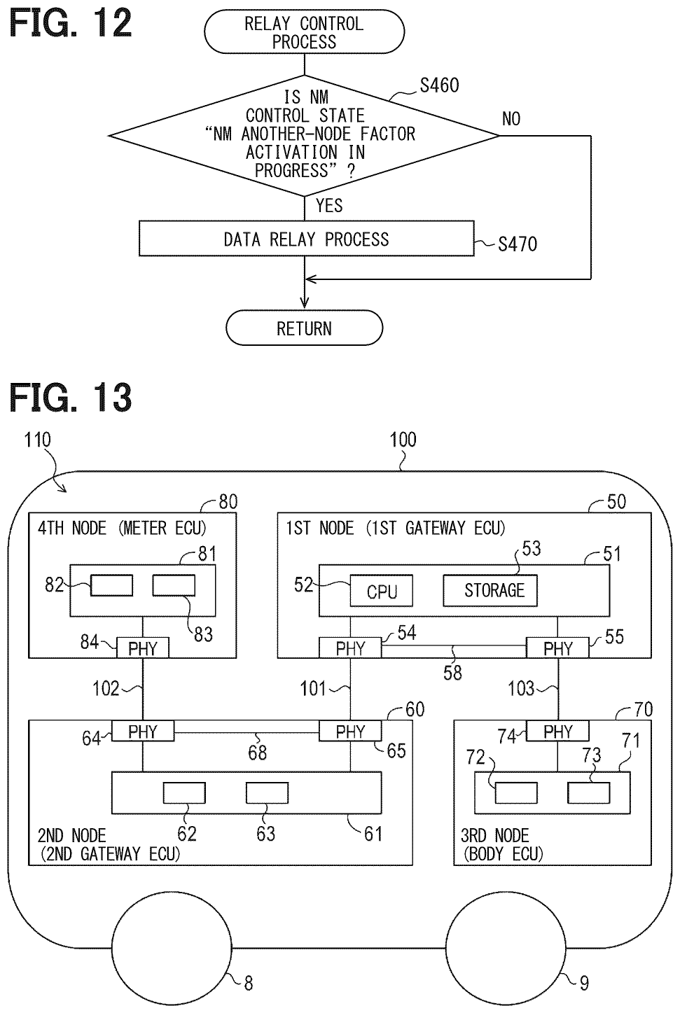

The control unit 11 includes a communication section 10A illustrated in FIG. 2. The communication section 10A is responsible for communication according to the predetermined communication standard described above. The communication section 10A is implemented by software. That is, the communication section 10A corresponds to a function implemented by the CPU 12 executing a program. The software that implements the communication section 10A includes programs for a communication control process (FIG. 6), a retransmission control process (FIG. 7), an another-node factor activation process (FIG. 11), and a relay control process (FIG. 12), which will be described later. These programs for implementing the communication section 10A are stored in the storage section 13. The communication section 10A will be described later with reference to FIG. 2.

The control unit 11 further includes a first node function section (not illustrated). The first node function section is responsible for an essential function as the first node 10, that is, a function as a gateway ECU in the present example. The first node function section is implemented by software. That is, the first node function section corresponds to a function implemented by the CPU 12 executing a program. The storage section 13 stores various programs for implementing the first node function section. The first node function section implements various functions in cooperation with the communication section 10A. Specifically, the first node function section transmits data through the communication section 10A as necessary. The first node function section acquires data from another node through the communication section 10A.

The function of the first node function section as the gateway ECU includes (i) a function that does not require communication with the other nodes through the PHYs 14, 15, and (ii) a function that requires communication with another node/the other nodes through the PHY 14 and/or the PHY 15. The first node function section issues an activation request to the communication section 10A when a subject-node activation factor occurs in the first node 10. The subject-node activation factor is an activation factor for executing communication with another node. The subject-node activation factor occurs without being caused by communication with another node.

The communication section 10A can selectively take one of an activated state or a sleep state as its operation state. In the activated state, all the functions of the communication section 10A are exerted. In the sleep state, some or almost all of the functions of the communication section 10A are stopped. In the sleep state, since the functions are stopped, the power consumption of the first node 10 is reduced more than in the activated state. In the present embodiment, in the sleep state of the communication section 10A, at least (i) a function corresponding to an activation request from the first node function section and (ii) a function corresponding to a wakeup signal to be described later are maintained.

The method of implementing the communication section 10A and the first node function section is not limited to software, and some or all of the elements may be implemented using one or more pieces of hardware. Specifically, some or all of the functions of the communication section 10A may be implemented by, for example, a digital circuit including many logic circuits, an analog circuit, or a combination thereof. The same applies to the first node function section. Furthermore, the same applies to a communication section 20A (cf. FIG. 2) and a second node function section in the second node 20 to be described later, and a communication section 30A (cf. FIG. 2) and a third node function section in the third node 30 to be described later.

Each of the PHY 14 and the PHY 15 is an electronic circuit configured to mainly perform the function of Layer 1. Each of the PHY 14 and the PHY 15 may include some or all of the functions of Layer 2. The first communication line 4 is connected to the PHY 14, and the second communication line 5 is connected to the PHY 15.

Each of the PHY 14 and the PHY 15 can selectively take one of the activated state or the sleep state as an operation state. In the activated state, all the functions of the PHY 14 and the PHY 15, such as transmission and reception of various signals and data, are exerted. In the sleep state, some or almost all of the functions of the PHY 14 and the PHY 15 are stopped. In the sleep state, since the function is stopped, power consumption is reduced more than in the activated state. In the present embodiment, in the sleep state, at least a function of transmitting and receiving a wakeup signal to be described later is maintained.

The PHY 14 and the PHY 15 are connected to each other via a connection line 18. The connection line 18 is used in a first transfer function to be described later.

As illustrated in FIG. 1, the second node 20 includes a control unit 21 and a PHY 24. The control unit 21 is connected to the PHY 24. The control unit 21 can transmit various signals and data to the other nodes and receive various signals and data from the other nodes through the PHY 24.

The control unit 21 implements various functions of the second node 20. The various functions include a function as the meter ECU described above, a communication function with the first node 10 and the third node 30, and the like. Communication with the third node 30 is performed, for example, by relaying the first node 10 as described later.

The control unit 21 includes a CPU 22 and a storage section 23. The basic configurations of the CPU 22 and the storage section 23 are similar to the configurations of the CPU 12 and the storage section 13 of the first node 10. That is, the control unit 21 is mainly configured by a known microcomputer.

The control unit 21 includes a communication section 20A illustrated in FIG. 2. The communication section 20A is responsible for communication according to the predetermined communication standard described above. The communication section 20A is implemented by software. That is, the communication section 20A corresponds to a function implemented by the CPU 22 executing a program. The software that implements the communication section 20A includes programs for the communication control process (FIG. 6), the retransmission control process (FIG. 7), and the another-node factor activation process (FIG. 11). These programs for implementing the communication section 20A are stored in the storage section 23. The communication section 20A will be described later with reference to FIG. 2.

The control unit 21 further includes a second node function section (not illustrated). The second node function section is responsible for an essential function as the second node 20, that is, a function as a meter ECU in the present example. The second node function section is implemented by software. That is, the second node function section corresponds to a function implemented by the CPU 22 executing a program. The storage section 23 stores various programs for implementing the second node function section. The second node function section implements various functions in cooperation with the communication section 20A. Specifically, the second node function section transmits data through the communication section 20A as necessary. The second node function section acquires data from another node through the communication section 20A.

The function of the second node function section as the meter ECU includes (i) a function that does not require communication with another node via the PHY 24, and (ii) a function that requires communication with another node via the PHY 24. The second node function section issues an activation request to the communication section 20A when a subject-node activation factor occurs in the second node 20.

The communication section 20A can selectively take one of the activated state or the sleep state as the operation state. In the activated state, all the functions of the communication section 20A are exerted. In the sleep state, some or almost all of the functions of the communication section 20A are stopped. In the sleep state, since the function is stopped, the power consumption of the second node 20 is reduced more than in the activated state. In the present embodiment, in the sleep state of the communication section 20A, at least (i) a function corresponding to the activation request from the second node function section and (ii) a function corresponding to the wakeup signal are maintained.

The first communication line 4 is connected to the PHY 24. The PHY 24 is basically configured similarly to the PHY 14. That is, the PHY 24 can also selectively take one of the activated state or the sleep state as the operation state.

As illustrated in FIG. 1, the third node 30 includes a control unit 31 and a PHY 34. The control unit 31 is connected to the PHY 34. The control unit 31 can transmit various signals and data to the other nodes and receive various signals and data from the other nodes through the PHY 34.

The control unit 31 implements various functions of the third node 30. The various functions include a function as the body ECU described above, a communication function with the first node 10 and the second node 20, and the like. Communication with the second node 20 is performed, for example, by relaying the first node 10 as described later.

The control unit 31 includes a CPU 32 and a storage section 33. The basic configurations of the CPU 32 and the storage section 33 are similar to the configurations of the CPU 12 and the storage section 13 of the first node 10. That is, the control unit 31 is mainly configured by a known microcomputer.

The control unit 31 includes a communication section 30A illustrated in FIG. 2. The communication section 30A is responsible for communication according to the predetermined communication standard described above. The communication section 30A is implemented by software. That is, the communication section 30A corresponds to a function implemented by the CPU 32 executing a program. The software that implements the communication section 30A includes programs for the communication control process (FIG. 6) and the another-node factor activation process (FIG. 11). These programs for implementing the communication section 30A are stored in the storage section 33. The communication section 30A will be described later with reference to FIG. 2.

The control unit 31 further includes a third node function section (not illustrated). The third node function section is responsible for an essential function as the third node 30, that is, a function as a body ECU in the present example. The third node function section is implemented by software. That is, the third node function section corresponds to a function implemented by the CPU 32 executing a program. The storage section 33 stores various programs for implementing the third node function section. The third node function section implements various functions in cooperation with the communication section 30A. Specifically, the third node function section transmits data through the communication section 30A as necessary. The third node function section acquires data from another node through the communication section 30A.

The function of the third node function section as the body ECU includes (i) a function that does not require communication with another node via the PHY 34, and (ii) a function that requires communication with another node via the PHY 34. The third node function section issues an activation request to the communication section 30A when a subject-node activation factor occurs in the third node 30.

The communication section 30A can selectively take one of the activated state or the sleep state as the operation state. In the activated state, all functions of the communication section 30A are exerted. In the sleep state, some or almost all of the functions of the communication section 30A are stopped. In the sleep state, since the function is stopped, the power consumption of the third node 30 is reduced more than in the activated state. In the present embodiment, in the sleep state of the communication section 30A, at least (i) a function corresponding to the activation request from the third node function section and (ii) a function corresponding to the wakeup signal are maintained.

The second communication line 5 is connected to the PHY 34. The PHY 34 is basically configured similarly to the PHY 14. That is, the PHY 34 can also selectively take one of the activated state or the sleep state as the operation state.

### (1-2) Specific Configuration of In-Vehicle Communication System

The communication function in the in-vehicle communication system 2 will be described more specifically with reference to FIG. 2. As illustrated in FIG. 2, the first node 10 includes the communication section 10A. The communication section 10A includes a communication control section 11a and a hardware control section 11b.

The communication control section 11a sets an operation state (hereinafter referred to as an “NM control state”) of the communication section 10A and performs various management of data communication according to the NM control state. The term “NM” is an abbreviation for “Network Management”. In the present embodiment, the NM control state can be set to any one of the following states: “NM subject-node factor activation in progress”, “NM another-node factor activation in progress”, and “NM stopped”.

The above “NM stopped” corresponds to the sleep state. That is, when the operation state of the communication section 10A is set to “NM stopped”, the communication section 10A transitions to the sleep state. On the other hand, “NM subject-node factor activation in progress” and “NM another-node factor activation in progress” both correspond to an activated state, that is, a state of waking up from the sleep state and being activated normally.

Specifically, “NM subject-node factor activation in progress in progress” is set when the communication control section 11a is activated upon receiving an activation request from the first node function section due to the occurrence of a subject-node activation factor. As will be described later with reference to FIG. 11, “NM another-node factor activation in progress” is set with the reception of the wakeup signal from another node during the sleep state as a trigger. When activated by a subject-node activation factor, the communication control section 11a transmits wakeup signals from the respective nodes (i.e., PHYs 14, 15) as described later, thereby activating the other nodes (i.e., second node 20 and third node 30) connected to the respective ports.

The wakeup signal may be in the form of an Ethernet frame or may be in a different form from the Ethernet frame. In the present first embodiment and a second embodiment to be described later, as an example, the wakeup signal is in a different from (e.g., a pulse signal with a predetermined cycle) from that of the Ethernet frame. The wakeup signal corresponds to an example of an activation request signal in the present disclosure. In the above and the following descriptions, “activate”, “activate (subject)”, and “activation in progress” mean “transition to the activated state”, “cause (subject) to transition to the activated state”, and “during the activated state”, respectively. In the present disclosure, the activation request signal transmitted from the first node may be the same as or at least partially different from the activation request signal transmitted from the second node.

The communication control section 11a controls communication between the first node 10 and another node during the activation of the communication control section 11a. When transmitting transmission data to another node, the communication control section 11a requests the hardware control section 11b to transmit the transmission data to the transmission target (i.e., that other node). Upon receiving the request, the hardware control section 11b passes the transmission data to one or both of the PHYs 14, 15 connected to the communication target or the communication targets and instructs the transmission. Thereby, the PHY 14 and/or the PHY 15 that has received the transmission instruction transmit the transmission data. The above “when transmitting transmission data to another node” includes transferring or relaying data received from another node to another distinct node. For example, the first node 10 transfers or relays data received from the second node 20 to the third node 30.

During activation, the communication control section 11a regularly transmits a predetermined Ethernet frame (hereinafter, “NM frame”) to each of the communication target nodes as a transmission destination. In the present first embodiment, the communication target nodes include the second node 20 and the third node 30. The NM frame functions to maintain the activated state for each of the communication target nodes.

As will be described later, the communication control section 11a transmits a wakeup signal when a retransmission condition is satisfied. The retransmission condition corresponds to an example of a transmission condition in the present disclosure. In the present embodiment, the communication control section 11a transmits the wakeup signal after the communication control section 11a is activated and before the retransmission condition is satisfied. Therefore, the transmission of the wakeup signal in response to, the satisfaction of the retransmission condition is hereinafter referred to as “retransmission”.

The hardware control section 11b individually controls the PHYs 14, 15 in response to various requests from the communication control section 11a. The control of the PHYs 14, 15 includes, for example, instructions for transmitting transmission data and setting the functions of the PHYs 14,15. When the hardware control section 11b further acquires reception data from another node via each of the PHYs 14, 15, the hardware control section b processes the reception data in cooperation with the communication control section 11a. When the reception data is addressed to the first node function section of the upper layer, the reception data is passed to the first node function section through the communication control section 11a.

The communication section 10A further includes an anomaly detection section 11c and a recovery section 11d. The anomaly detection section 11c determines, for each port where communication is performed, whether a node communicating with the port (hereinafter, “communication target node”) is in an anomalous communication state. The anomalous communication state means a state in which a communication target node activated by the wakeup signal from another node cannot normally communicate with that other node. In the present embodiment, the terms “port” and “PHY” are substantially synonymous.

The anomaly detection section 11c of the present embodiment determines whether the communication target node is in the anomalous communication state using at least one of first to third detection methods.

In the first detection method, (i) a prescribed command is periodically transmitted to the communication target node, and (ii) it is determined whether response data to the prescribed command has been received properly from the communication target node. In the present embodiment, for example, when there is a port in a non-response timeout state, it is determined that the communication target node corresponding to the port is in the anomalous communication state. The non-response timeout means that response data is not received properly even when a time equal to or longer than a first time threshold elapses after the transmission of the prescribed command. The first time threshold value may be determined as appropriate. The first time threshold value may be longer than a prescribed response time, for example. The prescribed response time is a time required from the transmission of the prescribed command to the reception of the response data in the normal state of the in-vehicle communication system 2. Specifically, the first time threshold value may be, for example, n times the prescribed response time (n is a natural number).

The transmission cycle of the prescribed command may also be determined as appropriate. For example, it may be desirable to return the communication target node in the anomalous communication state to the normal state until a predetermined allowable return time elapses after the node enters the anomalous communication state (i.e., to bring the node into a state allowing normal communication). In this case, the transmission cycle of the prescribed command may be determined to be shorter than the allowable return time. Specifically, the transmission cycle of the prescribed command may be determined in consideration of, for example, the time required for initialization, communication connection reestablishment, and the like. More specifically, the transmission cycle of the prescribed command may be set at or near ½ of the allowable return time.

In the second detection method, the link down of the communication target port is detected. As is well known, link down means a state in which proper physical transmission and reception of electrical signals to and from the communication target node are disabled. As a specific aspect of link down, for example, a state in which there is no physical connection with the communication target node. A state opposite to link down, in which proper physical transmission and reception of electrical signals to and from the communication target node is possible, is generally referred to as “link up”.

In the present embodiment, for example, link down is directly detected by the corresponding PHY. When a link down is detected by the PHY, the anomaly detection section 11c receives notification of link down detection from that PHY. When detecting a link down (i.e., when receiving its notification from the PHY), the anomaly detection section 11c determines that the communication target node connected to the port for which the link down has been detected is in the anomalous communication state.

In the third detection method, a non-reception timeout of a periodic message (corresponding to an example of “predetermined data” of the present disclosure) from the communication target node is detected. In the present embodiment, a node with its NM control state set to “NM another-node factor activation in progress”, which is being activated, that is, a node activated by an activation request from another node, periodically transmits a periodic message. The non-reception timeout means that the periodic message is not continuously received for a second time threshold or longer. The second time threshold may be determined as appropriate to be a time longer than the transmission cycle of the periodic message. Specifically, the second time threshold may be, for example, n times the transmission cycle of the periodic message. It may be desirable to return to communication within a predetermined period of time after normal communication with the communication target node has been lost. In this case, the second time threshold value may be determined in consideration of the predetermined period of time.

The transmission cycle of the periodic message may be determined as appropriate. The transmission cycle of the periodic message may be, for example, a constant cycle common to all nodes or a constant cycle set individually for each node. For example, when the transmission source node of the periodic message enters the anomalous communication state, it may be desirable to return the transmission source node to the normal state in which communication is possible before a predetermined allowable return time elapses. In this case, the transmission cycle of the periodic message in the transmission source node may be shorter than the allowable return time. Specifically, the transmission cycle may be determined in consideration of, for example, the time required for initialization of the transmission source node, communication connection re-establishment, and the like. More specifically, the transmission cycle may be set to, for example, at or near ½ of the allowable return time.

When each of a plurality of types of periodic messages is periodically transmitted, for example, one or more specific types of periodic messages may be set as the detection target of the non-reception timeout. Alternatively, all of the plurality of types of periodic messages may be set as the non-reception timeout detection targets. That is, after a first type of periodic message from the plurality of types of periodic messages is received, if the first type of periodic message is not received again but a second type of periodic message is received before the second time threshold elapses, this situation does not correspond to a non-reception timeout. Transmission cycles of the plurality of types of periodic messages may be the same or different from each other.

Each of the first to third detection methods described above is merely an example of the detection method for the anomalous communication state. In addition to the first to third detection methods or instead of the first to third detection methods, the anomaly detection section 11c may determine whether the communication target node is in the anomalous communication state by a method different from the first to third detection methods.

Upon detecting that the communication target node is in the anomalous communication state, the anomaly detection section 11c notifies the recovery section 11d that the anomalous communication state has occurred. At this time, the anomaly detection section 11c also notifies anomalous port information. The anomalous port information refers to a port connected to the communication target node where the anomalous communication state has been detected.

When the retransmission condition is satisfied after the communication section 10A activated by a subject-node activation factor transmits the wakeup signal to each port, the recovery section 11d retransmits the wakeup signal. More specifically, when the retransmission condition is satisfied, the recovery section 11d requests the communication control section 11a to perform retransmission. Thereby, the wakeup signal is retransmitted under the control of the communication control section 11a.

In the present embodiment, the retransmission condition includes, for example, first to third retransmission conditions. The recovery section 11d may adopt any one or more of the first to third retransmission conditions. When two or more retransmission conditions among the first to third retransmission conditions are adopted, the recovery section 11d may retransmit the wakeup signal when any one of the two or more retransmission conditions is satisfied.

The first retransmission condition is satisfied in response to the arrival of a retransmission timing. The retransmission timing is set to arrive periodically and repeatedly. The retransmission timing corresponds to an example of a transmission timing in the present disclosure. When the first retransmission condition is satisfied, the wakeup signal is retransmitted to all the communication target nodes.

The cycle of the retransmission timing may be determined as appropriate. The cycle of the retransmission timing may be determined to be shorter than the allowable return time, for example, similarly to the transmission cycle of the prescribed command described above. Alternatively, the transmission cycle of the NM frame described above may be determined as the cycle of the retransmission timing. In this case, the transmission timing for the NM frame and the retransmission timing for the wakeup signal may be set in any manner relative to each other. In the present embodiment, a cycle for executing the retransmission control process of FIG. 7, which will be described later, corresponds to the arrival cycle of the retransmission timing.

The second retransmission condition is satisfied in response to the detection of the anomalous communication state of the communication target node by the first detection method described above.

The third retransmission condition is satisfied in response to the detection of the anomalous communication state of the communication target node by the second detection method or the third detection method described above.

In both cases where the second retransmission condition is satisfied and the third retransmission condition is satisfied, the wakeup signal is retransmitted to the communication target node where the anomalous communication state has been detected. However, in this case, the wakeup signal may be retransmitted to all the communication target nodes.

When the second or third retransmission condition is not adopted as the retransmission condition, detection of the anomalous communication state is basically unnecessary. Therefore, in this case, the anomaly detection section 11c may be omitted.

The first node 10 further includes the first transfer function described above and a second transfer function. The first transfer function is a function that, when one of the PHY 14 or the PHY 15 receives the wakeup signal, the wakeup signal is transferred to the other and is caused to be transmitted from the other. For example, when the PHY 14 receives the wakeup signal from the second node 20, the wakeup signal is transferred, either as is or after being appropriately processed, to the PHY 15 via the connection line 18. The PHY 15 transmits the transferred wakeup signal via the second communication line 5. As a result, the wakeup signal transmitted from the second node 20 to the first node 10 is also received by the third node 30 via the first node 10.

Conversely, when the PHY 15 receives the wakeup signal transmitted from the third node 30, the wakeup signal is transferred from the PHY 15 to the first communication line 4 through the connection line 18 and the PHY 14. As a result, the second node 20 is activated in response to the transmission of the wakeup signal from the third node 30.

As described above, the first transfer function is a function of transferring the wakeup signal by hardware processing (in other words, wired logic) without depending on software processing according to a computer program.

Similarly to the first transfer function, the second transfer function is a function of transferring the wakeup signal received by one of the PHY 14 or the PHY 15 to the other and outputting the wakeup signal from the other. However, the second transfer function is implemented by software processing by the communication section 10A. That is, when one of the PHY 14 or the PHY 15 receives the wakeup signal, the communication section 10A transfers the wakeup signal, either as is or after being appropriately processed, from the other.

The first node 10 may include only one of the first transfer function or the second transfer function.

The communication section 10A further includes a data relay function. The data relay function is a function of relaying communication between another node and another distinct node when activated by the wakeup signal from the former node. For example, it is assumed that the first node 10 is activated by the wakeup signal from the second node 20. In this case, upon receiving data addressed to the third node 30 from the second node 20, the communication section 10A transmits (i.e., relays) the data to the third node 30. Furthermore, the communication section 10A determines whether the retransmission condition is satisfied for the third node 30 as the relay destination. This determination is basically the same as described above. When the retransmission condition is satisfied for the third node 30, the communication section 10A retransmits the wakeup signal to the third node 30.

Next, the second node 20 includes the communication section 20A described above, which is implemented by software. The communication section 20A includes a communication control section 21a, a hardware control section 21b, an anomaly detection section 21c, and a recovery section 21d. The communication control section 21a, the hardware control section 21b, the anomaly detection section 21c, and the recovery section 21d are basically configured and function similarly to the communication control section 11a, the hardware control section 11b, the anomaly detection section 11c, and the recovery section 11d in the first node 10, respectively, except that one port (i.e., PHY 24) is provided and the direct communication target node is the first node 10. Therefore, the above description of the first node 10 based on FIG. 2 basically applies to the second node 20 if the port is replaced with the PHY 24 and the communication target node is replaced with the first node 10.

Next, the third node 30 includes the communication section 30A described above, which is implemented by software. The communication section 30A includes a communication control section 31a and a hardware control section 31b. These are basically configured and function similarly to the communication control section 11a and the hardware control section 11b in the first node 10, except that one port (i.e., PHY 34) is provided and the communication target node is the first node 10.

However, the communication section 30A of the third node 30 does not include functions corresponding to the anomaly detection section 11c and the recovery section 11d of the first node 10. Therefore, the communication control section 31a and the hardware control section 31b of the third node 30 do not include functions corresponding to the functions related to the anomaly detection section 11c and the recovery section 11d, compared to the communication control section 11a and the hardware control section 11b of the first node 10.

Except for such a difference from the first node 10, the above description regarding the communication control section 11a and the hardware control section 11b of the first node 10 basically applies to the communication control section 31a and the hardware control section 31b of the third node 30. The third node 30 may also include functions corresponding to the anomaly detection section 11c and the recovery section 11d. That is, the communication section 30A may include a program for the retransmission control process (FIG. 7) and be configured to execute the program.

### (1-3) Operation Example of In-Vehicle Communication System

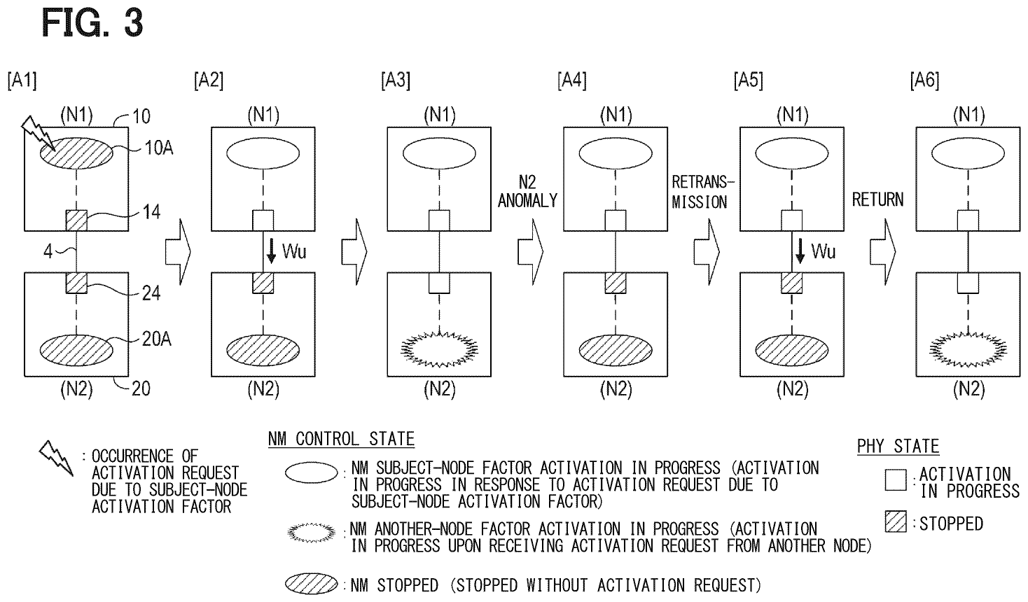

Next, operation examples of the in-vehicle communication system 2 of the first embodiment will be described with reference to FIG. 3 to FIG. 5. FIG. 3 to FIG. 5 all assume that, for example, at least one of the second or third retransmission condition is adopted as the retransmission condition.

First, an operation example illustrated in FIG. 3 will be described. In FIG. 3, only the first node 10 and the second node 20 are extracted for simplicity of description. In FIG. 3, state A1 indicates a state in which both the first node 10 and the second node 20 are in the sleep state. Specifically, in the first node 10, the communication section 10A is set to “NM stopped”, and the PHY 14 is also set to “stopped” (i.e., sleep state). In the second node 20 as well, the communication section 20A is set to “NM stopped”, and the PHY 24 is set to “stopped” (i.e., sleep state).

In state A1, the first node 10 is activated when a subject-node activation factor occurs in the first node 10 (cf. state A2). Specifically, the communication section 10A is activated and thereby set to “NM subject-node factor activation in progress”. The PHY 14 is also activated. The PHY 14 is activated, for example, by the communication control section 11a instructing the PHY 14 to activate via the hardware control section 11b.

The activated first node 10 transmits the wakeup signal from the port (i.e., PHY 14) connected to the second node 20 to the second node 20.

Upon receiving the wakeup signal from the first node 10, the second node 20 is activated (cf. state A3). Specifically, the PHY 24 is activated by receiving the wakeup signal. The activated PHY 24 notifies the communication section 20A (specifically, the hardware control section 21b) of the activation. This activates the communication section 20A. At this time, the communication section 20A is set to “NM another-node factor activation in progress”. When the first node 10 and the second node 20 are activated in this manner, communication between the two nodes is performed. In the present embodiment, when “activation” or “activated state” is referred to for any node, this means the activation or activated state of both the communication section and the PHY in the node, unless otherwise specified. Similarly, when “sleep state” is referred to for any node, this means the sleep state of both the communication section and the PHY in the node, unless otherwise specified.

However, “sleep state” in the description “when the . . . node is in the sleep state” in the present disclosure also includes an aspect in which only one of the communication section or the PHY in the node is in the sleep state.

When the first detection method described above is adopted in the anomaly detection section 11c, the prescribed command is periodically transmitted from the first node 10 to the second node 20. When the second detection method described above is adopted in the anomaly detection section 11c, the link down of the port (PHY 24) is monitored. When the anomaly detection section 11c adopts the third detection method described above, a periodic message is periodically transmitted from the second node 20 to the first node 10.

It is assumed, for example, that during communication between the first node 10 and the second node 20, the second node 20 enters the anomalous communication state. In this case, the second node 20 transitions to the sleep state (cf. state A4). The transition of the second node 20 to the sleep state more means, in more detail, that (i) the communication section 20A of the second node 20 transitions to “NM stopped” and (ii) the PHY 24 transitions to “stopped”. The transition to the sleep state in response to the entry of the anomalous communication state is one of the specifications of in-vehicle Ethernet.

The anomaly detection section 11c of the first node 10 detects that the second node 20 has entered the anomalous communication state. As a result, the retransmission condition is satisfied in the first node 10. Therefore, the wakeup signal is retransmitted from the first node 10 to the second node 20 (cf. state A5). “Wu”, shown in FIG. 3 and other drawings, refers to the wakeup signal.

In the present embodiment, each node is activated from the sleep state when a subject-node activation factor occurs or when the wakeup signal is received from another node. Therefore, after the second node 20 transitions to the sleep state due to the occurrence of the anomalous communication state, even if the anomalous communication state is resolved, the second node 20 is not activated due to the resolution of the anomalous communication state. The second node 20 maintains the sleep state even if the anomalous communication state is resolved. The same applies to the other nodes to be described later.

Upon receiving the wakeup signal retransmitted from the first node 10, the second node 20 that has transitioned to the sleep state due to the occurrence of the anomalous communication state is reactivated (cf. state A6). This enables the first node 10 to communicate with the second node 20 again. The second node 20 may not be activated upon receiving the retransmitted wakeup signal while the anomalous communication state continues.

In the operation example of FIG. 3, if the retransmission condition includes the first retransmission condition, when communication between the first node 10 and the second node 20 is started (cf. state A3), the wakeup signal is periodically retransmitted from the first node 10 to the second node 20. Therefore, even if the second node 20 enters the anomalous communication state, the second node 20 can be reactivated by receiving the wakeup signal retransmitted from the first node 10.

The factor of unintentionally transitioning to the sleep state during the execution of communication is not limited to the occurrence of the anomalous communication state. Even if the anomalous communication state does not occur, the state may unintentionally transition to the sleep state. In contrast, when the retransmission condition includes the first retransmission condition, even if the second node 20 transitions to the sleep state due to a factor different from the occurrence of the anomalous communication state, the second node 20 can be reactivated.

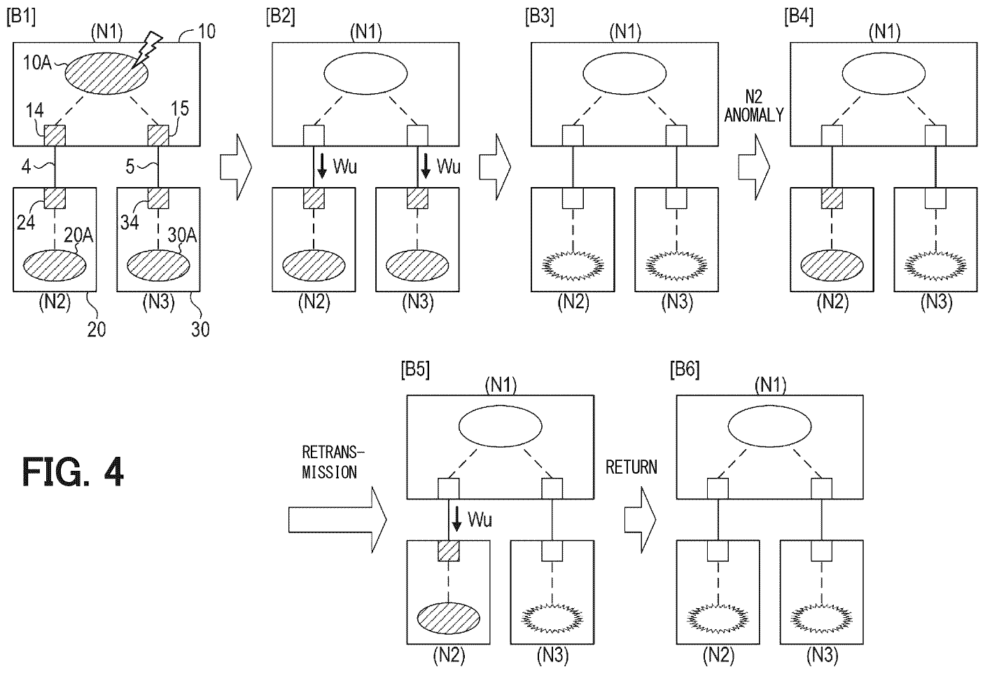

Next, an operation example illustrated in FIG. 4 will be described. FIG. 4 illustrates all of the first to third nodes 10 to 30. In FIG. 4, state B1 indicates a state in which all of the first to third nodes 10 to 30 are in the sleep state. Specifically, in the first node 10, the communication section 10A is set to “NM stopped”, and the PHY 14 and the PHY 15 are also set to “stopped” (i.e., sleep state). In the second node 20 as well, the communication section 20A is set to “NM stopped”, and the PHY 24 is set to “stopped” (i.e., sleep state). In the third node 30 as well, the communication section 30A is set to “NM stopped”, and the PHY 34 is set to “stopped” (i.e., sleep state).

In state B1, the first node 10 is activated when a subject-node activation factor occurs in the first node 10 (cf. state B2). Specifically, the communication section 10A is activated and thereby set to “NM subject-node factor activation in progress”. Each of the two PHYs 14, 15 is also activated. Similarly to the PHY 14, the PHY 15 is activated by the communication control section 11a instructing the PHY 15 to activate via the hardware control section 11b.

The activated first node 10 transmits wakeup signals to the second node 20 and the third node 30 from the respective ports (i.e., PHYs 14, 15) to which the communication target nodes (i.e., second node 20 and third node 30) are connected.

Upon receiving the wakeup signal from the first node 10, the second node 20 and the third node 30 are activated (cf. state B3). At this time, the communication section 20A of the second node 20 and the communication section 30A of the third node 30 are both set to “NM another-node factor activation in progress”. When the first to third nodes 10 to 30 are activated in this manner, three-party communication is performed.

It is assumed that, for example, the second node 20 enters the anomalous communication state during the three-party communication. In this case, similarly to state A4 in FIG. 3 described above, the second node 20 transitions to the sleep state (cf. state B4). This anomalous communication state is detected by the anomaly detection section 11c of the first node 10. Thereby, the retransmission condition is satisfied in the first node 10, and the wakeup signal is retransmitted from the first node 10 to the second node 20 (cf. state B5). In this case, the retransmission destination of the wakeup signal is only the second node 20 where the anomalous communication state has been detected. However, the wakeup signal may be retransmitted to a node where the anomalous communication state has not been detected (the third node 30 in the example of FIG. 4).

When the second node 20 that has transitioned to the sleep state due to the occurrence of the anomalous communication state receives the wakeup signal retransmitted from the first node 10, the second node is reactivated similarly to the example of FIG. 3 (cf. state B6). This enables the first node 10 to communicate with the second node 20 again.

In the operation example of FIG. 4, if the retransmission condition includes the first retransmission condition, when the three-party communication is started (cf. state B3), the wakeup signals are periodically retransmitted from the first node 10 to the second node 20 and the third node 30, respectively. Therefore, even if the second node 20 enters the anomalous communication state, the second node 20 can be reactivated by receiving the wakeup signal retransmitted from the first node 10. The same applies to the third node 30.

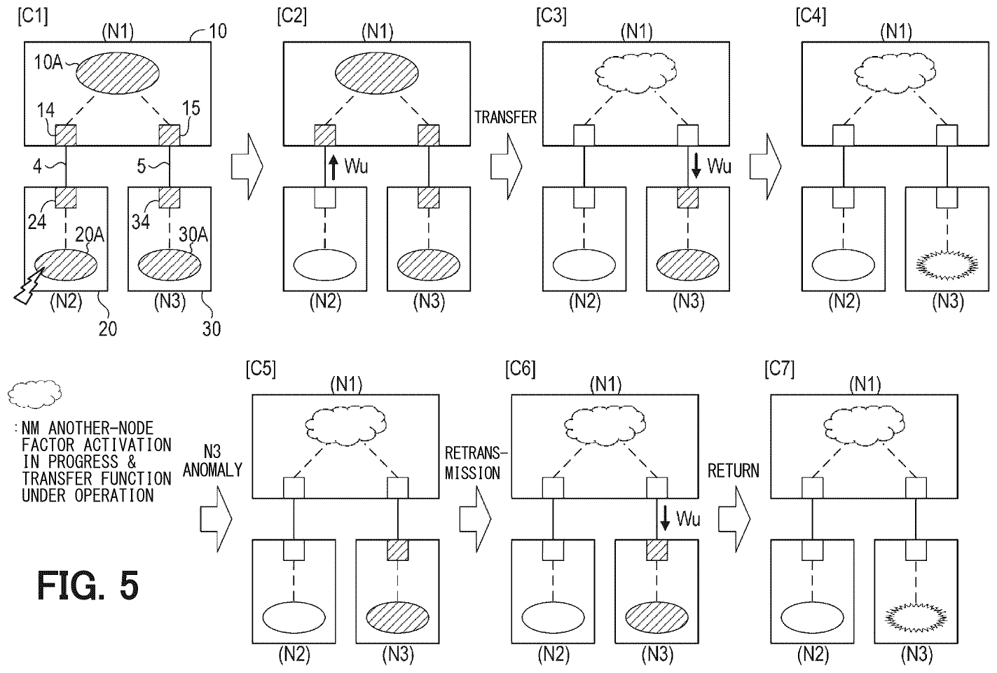

Next, an operation example illustrated in FIG. 5 will be described. FIG. 5 illustrates an operation example in which the wakeup signal transmitted from the second node 20 is transferred to the third node 30 by the first node 10.

In FIG. 5, state C1 indicates a state in which all of the first to third nodes 10 to 30 are placed into the sleep state, similarly to state B1 of FIG. 4 described above.

In state C1, the second node 20 is activated when a subject-node activation factor occurs in the second node 20 (cf. state C2). Specifically, the communication section 20A is activated and thereby set to “NM subject-node factor activation in progress”. The PHY 24 is also activated.

The activated second node 20 transmits the wakeup signal from the port (i.e., PHY 24), to which the communication target node (i.e., first node 10) is connected, to the first node 10.

Upon receiving the wakeup signal from the second node 20, the first node 10 is activated (cf. state C3). More specifically, when the PHY 14 receives the wakeup signal from the second node 20, the PHY 14 is activated, whereby the communication section 10A is activated. At this time, the communication section 10A of the first node 10 is set to “NM another-node factor activation in progress”.

Furthermore, in the first node 10, the first transfer function and the second transfer function described above operate. That is, upon receiving the wakeup signal, the PHY 14 transfers the wakeup signal to the PHY 15 via the connection line 18. Moreover, the communication section 10A also transfers the wakeup signal received by the PHY 14 via the PHY 15 by software processing. When the PHY 15 is in the sleep state at the time of transferring the wakeup signal by the second transfer function, the communication section 10A activates the PHY 15 to transfer the wakeup signal. The PHY 15 may be configured to be activated upon receiving a transfer instruction for the wakeup signal from the communication section 10A while the PHY 15 is in the sleep state. That is, the transfer instruction for the wakeup signal may also serve as an activation instruction.

The PHY 15 is activated upon receiving the wakeup signal from the PHY 14 by the first transfer function or upon receiving an activation request (including a transfer instruction for the wakeup signal) from the communication section 10A by the second transfer function. As a result, the wakeup signal is transmitted from the PHY 15 to the third node 30. Only one of the first transfer function or the second transfer function may be provided. In this case, the one transfer function activates the PHY 15, and the PHY 15 transmits the wakeup signal to the third node 30.

When the first to third nodes 10 to 30 are activated in this manner, three-party communication is performed. In this case, the data relay function described above operates in the communication section 10A of the first node 10. That is, upon receiving data addressed to the third node 30 from the second node 20, the first node 10 transmits the data to the third node 30.

Furthermore, the communication section 10A determines whether the retransmission condition is satisfied for the third node 30 as the relay destination. At this time, for example, when the retransmission condition is satisfied due to the third node 30 entering the anomalous communication state (i.e., the second retransmission condition or the third retransmission condition is satisfied) (cf. state C5), the wakeup signal is retransmitted from the first node 10 to the third node 30 (cf. state C6). As a result, the third node 30 is reactivated (cf. state C7).

In the operation example of FIG. 5, it is assumed that the first retransmission condition is included in the retransmission condition to the third node 30 in the communication section 10A. In this case, when the data relay function is activated (cf. state C4), the wakeup signal is periodically retransmitted from the first node 10 to the third node 30. Therefore, even if the third node 30 enters the anomalous communication state, the third node 30 can be reactivated based on the wakeup signal retransmitted from the first node 10.

In FIG. 5, the case where the relay destination node is the third node 30 has been described as an example. However, even if the relay destination node is other than the third node 30, the communication section 10A performs determination of the retransmission condition, retransmission, and the like for the relay destination node in the same manner as described. Furthermore, when there are a plurality of relay destination nodes, the communication section 10A may individually perform determination of the retransmission condition, retransmission, and the like for each of the plurality of nodes.

### (1-4) Various Processes by Communication Section

Next, various processes for implementing the various functions described above will be described.

### (1-4-1) Communication Control Process

First, a communication control process executed in each of the first to third nodes 10 to 30 will be described with reference to FIG. 6. The communication control process corresponds to a process by each of the communication sections 10A to 30A. The CPUs 12, 22, 32 of the first to third nodes 10 to 30 start operating as the communication sections 10A to 30A, respectively, upon receiving electric power supply and starting operation. The operation of the communication section 10A includes periodically and repeatedly executing the communication control process. The same applies to the communication sections 20A, 30A. Hereinafter, in the description of each flowchart in the present embodiment, for convenience of description, the execution subject will be described as the communication section 10A of the first node 10 as an example.

Upon starting the operation, the communication section 10A (specifically, the CPU 12) transitions itself and each of the PHYs 14, 15 to the sleep state and starts the communication control process.

Upon starting the communication control process, the communication section 10A determines in S110 whether an activation request has occurred due to a subject-node activation factor. As described above, the subject-node activation factor in the first node 10 includes, for example, an activation request from the first node function section. When the activation request due to the subject-node activation factor has not occurred, the communication section 10A terminates the present process. When the activation request due to the subject-node activation factor has occurred, the communication section 10A activates itself in S120. Specifically, the operation state of the communication control section 11a is set to “NM subject-node factor activation in progress”.

In S130, the communication section 10A executes a wakeup signal transmission process. Specifically, first, in S131, the communication control section 11a requests the hardware control section 11b to transmit a wakeup signal. Next, in S132, the hardware control section 11b that has received the request activates both the PHYs 14, 15. Furthermore, in S133, each of the PHYs 14, 15 is requested to transmit the wakeup signal. As a result, the wakeup signal is transmitted from each of the PHYs 14, 15.

After the wakeup signal is transmitted, the communication section 10A starts a communication process in S140. That is, communication with each communication target node connected to each port is started. During the communication, the communication control section 11a regularly transmits the NM frame to each port as described above. In the communication process of S140, mainly, communication according to a communication request from the upper layer of the occurrence source of the activation request (e.g., the first node function section in the first node 10) is performed. That is, communication between the upper layers of each node is performed via the communication section of the lower layer in each node.

In S150, the communication section 10A determines whether a communication termination condition is satisfied. When the communication termination condition is not satisfied, the communication section 10A repeats the determination process of S140 while continuing the communication process. The determination process of S140 may be repeated at any cycle. The determination process of S140 may be performed aperiodically. The communication termination condition may be determined in any manner. In the present embodiment, when communication becomes unnecessary, the upper layer notifies the communication control section 11a of that fact. Therefore, the communication termination condition may be satisfied, for example, when the communication unnecessity is notified from the upper layer. Furthermore, for example, the communication termination condition may be satisfied when a state in which no data is transmitted to or received from the communication target continues for a predetermined period of time.

When the communication termination condition is satisfied in S150, the communication section 10A causes the first node 10 to transition to the sleep state in S160. At this time, the communication control section 11a sets the NM control state to “NM stopped” and sets the PHYs 14, 15 to “stopped” via the hardware control section 11b.

The communication control process of FIG. 6 is basically similarly performed in the second node 20 and the third node 30, except that the corresponding PHY, communication target node, and other components differ.

### (1-4-2) Retransmission Control Process

Next, the retransmission control process will be described with reference to FIG. 7. The retransmission control process is executed (i) when activation occurs due to the subject-node activation factor, and (ii) after the communication process of S140 is started in the communication control process of FIG. 6. The retransmission control process is executed in at least the node including the recovery section. Here, as an example, a description will be given assuming that the retransmission control process is executed in the first node 10. The retransmission control process is periodically and repeatedly executed during the activation of the communication section 10A. The execution timing for the retransmission control process that come periodically corresponds to the retransmission timing described above and corresponds to an example of a transmission timing in the present disclosure.

Upon starting the retransmission control process, the communication section 10A of the first node 10 determines in S210 whether the NM control state of the communication section 10A is “NM subject-node factor activation in progress”. The NM control state being “NM subject-node factor activation in progress” indicates that the upper layer needs communication. When the NM control state is not “NM subject-node factor activation in progress”, the communication section 10A terminates the present process. When the NM control state is “NM subject-node factor activation in progress”, the communication section 10A executes a retransmission process in S220. Specific examples of the retransmission process are illustrated in FIG. 8 to FIG. 10.

FIG. 8 illustrates the retransmission process executed when the first retransmission condition is adopted as the retransmission condition. Upon starting the retransmission process of FIG. 8, the communication section 10A executes a wakeup signal retransmission process in S260. Specifically, first, in S261, the communication section 10A requests the communication control section 11a from the recovery section 11d to transmit the wakeup signal to the retransmission target port. The target ports in the first retransmission condition are all ports (the PHYs 14, 15 in the present first embodiment). In the next S262, the communication control section 11a that has received this request requests the hardware control section 11b to transmit the wakeup signal to the target port. Furthermore, in S263, the hardware control section 11b that has received the request requests all the target ports (PHYs 14, 15) to retransmit the wakeup signal. As a result, the wakeup signal is retransmitted from each of the PHYs 14, 15.

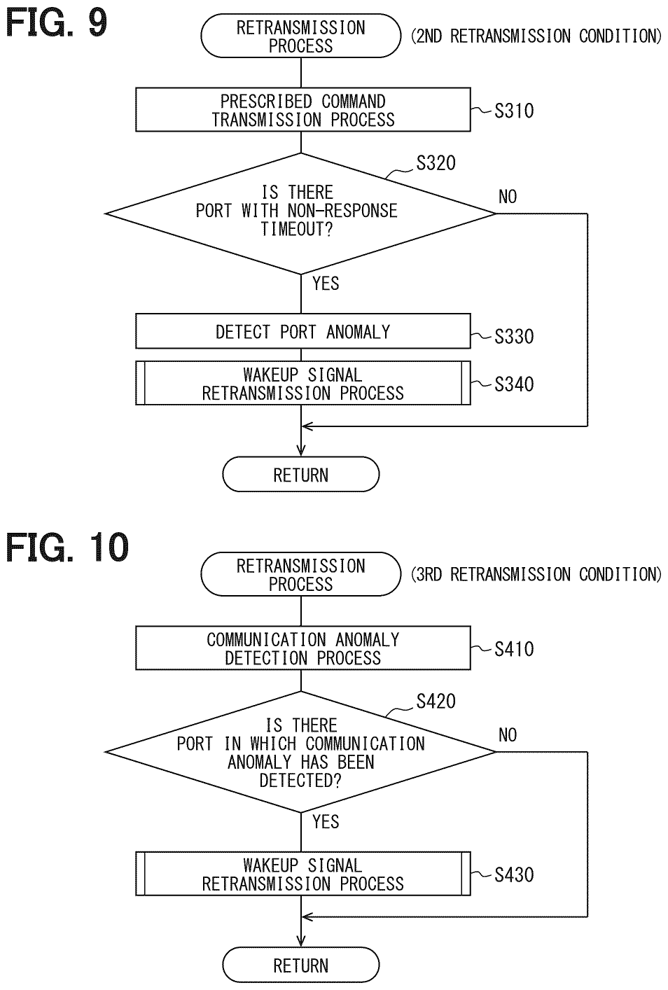

Next, FIG. 9 illustrates the retransmission process executed when the second retransmission condition is adopted as the retransmission condition. Upon starting the retransmission process of FIG. 9, the communication section 10A transmits a prescribed command from each port to the communication target node in S310. The present process is performed by the anomaly detection section 11c.

In S320, the communication section 10A determines whether there is a port in which a non-response timeout has occurred. That is, the communication section 10A determines whether there is a port that does not properly receive response data to the prescribed command.

When there is no port in which the non-response timeout has occurred, the communication section 10A terminates the present process. On the other hand, when there is a port in which the non-response timeout has occurred, the communication section 10A performs port anomaly detection in S330. The present process is performed by the anomaly detection section 11c. Specifically, the anomaly detection section 11c notifies the recovery section 11d of the occurrence of the anomaly and the corresponding port.

In step S340, the communication section 10A executes a wakeup signal retransmission process. The wakeup signal retransmission process of S340 is the same as the wakeup signal retransmission process of S260, except that the retransmission target port is only the port in which the non-response timeout has occurred. Therefore, a detailed description of S340 is omitted.

Next, FIG. 10 illustrates the retransmission process executed when the third retransmission condition is adopted as the retransmission condition. Upon starting the retransmission process of FIG. 10, the communication section 10A executes the communication anomaly detection process in S410. Specifically, the communication section 10A detects the anomalous communication state of the communication target node by using the second detection method and/or the third detection method described above.

In S420, the communication section 10A determines whether there is a port for which the anomalous communication state has been detected by the process of S410. When there is a port for which the anomalous communication state has been detected, the communication section 10A executes a wakeup signal retransmission process in S430. The wakeup signal retransmission process of S430 is the same as the wakeup signal retransmission process of S260 in FIG. 8, except that the retransmission target port is only the port for which the anomalous communication state has been detected. Therefore, a detailed description of S430 is omitted.

### (1-4-3) Another-Node Factor Activation Process

Next, the another-node factor activation process will be described with reference to FIG. 11. In the present embodiment, all of the first to third nodes 10 to 30 can execute the another-node factor activation process. Here, as an example, a description will be given assuming that the another-node factor activation process is executed in the first node 10.

Upon starting the operation, the communication section 10A transitions itself and the PHYs 14, 15 to the sleep state as described above and starts the another-node factor activation process. The communication section 10A may execute the another-node factor activation process in parallel (e.g., as multitasking) with the communication control process described above (cf. FIG. 6), for example.

Upon starting the another-node factor activation process, the communication section 10A determines whether the wakeup signal has been received from another node in S510. When the wakeup signal is not received from another node, the communication section 10A terminates the present process. When the wakeup signal is received from another node, the communication section 10A activates the first node 10 in S520. In S530, the communication section 10A transfers the wakeup signal to a port other than the port from which the wakeup signal has been received in S510. That is, in S530, the communication section 10A activates the second transfer function.

In S540, the communication section 10A determines whether an NM frame addressed to the subject node has been received at the port that has been activated after receiving the wakeup signal. When the NM frame addressed to the subject node has not been received, the communication section 10A determines, in S590, whether a certain period of time has elapsed since the activation in S520. When the certain period of time has not elapsed, the process returns to S540. When the certain period of time has elapsed, the communication section 10A shifts the first node 10 to the sleep state in S580. That is, the communication control section 11a sets the operation state to “NM stopped” and shifts the communication section 10A to the sleep state. Furthermore, the PHY being activated is shifted to the sleep state.

When the NM frame addressed to the subject node is received in S540, the communication section 10A sets the NM control state of the communication control section 11a to “NM another-node factor activation in progress” in S550. The communication section 10A starts the communication process in S560. For example, the communication section 10A starts communication with the node that is the transmission source of the wakeup signal.

In S570, the communication section 10A determines whether the communication termination condition is satisfied. When the communication termination condition is not satisfied, the communication section 10A repeats the determination process of S570 while continuing the communication process. The determination process of S570 may be repeated at any cycle. The determination process of S570 may be performed aperiodically. The communication termination condition in S570 may be determined in any manner. The communication termination condition may be satisfied when a state in which no data is transmitted to or received from the communication target node continues for a predetermined period of time.

When the communication termination condition is satisfied in S570, the communication section 10A causes the first node 10 to transition to the sleep state in S580. At this time, the communication control section 11a sets the NM control state to “NM stopped”, and sets the PHY started in S520 to “stopped” via the hardware control section 11b.

The activation in S520 can be said to be provisional activation in a state where the need for activation of the subject node is unclear. In contrast, the process of S550 can be said to be deterministic activation, performed in response to the confirmation by the NM frame that the activation of the subject node is necessary.

### (1-4-4) Relay Control Process

Next, the relay control process will be described with reference to FIG. 12. The relay control process is executed when the communication section 10A of the first node 10 is activated by the another-node factor activation process of FIG. 11. Upon starting the communication process of S560 in an another-node factor activation process of FIG. 11, the communication section 10A executes the relay control process in FIG. 12 in parallel.

Upon starting the relay control process, the communication section 10A determines whether the NM control state is “NM another-node factor activation in progress” in S460. When the NM control state is “NM another-node factor activation in progress”, the communication section 10A executes the data relay process in S470. Specifically, the communication section 10A executes the data relay function described above. The data relay function relays communication between another node, which is the transmission source of the wakeup signal that has caused its own activation, and a node different from that other node. The data relay function further includes the retransmission control of the wakeup signal for the relay destination node, as described above. Therefore, in S470, a retransmission process similar to that in S220 of FIG. 7 is also performed for the relay destination node.

### 2. Second Embodiment

### (2-1) Outline of In-Vehicle Communication System

An in-vehicle communication system 110 of a second embodiment illustrated in FIG. 13 is installed in a vehicle 100. Similarly to the vehicle 1, the vehicle 100 is in the form of, for example, a four-wheeled automobile. The in-vehicle communication system 110 of the second embodiment differs from the in-vehicle communication system 2 of the first embodiment in the number of nodes and the types of some nodes (i.e., types of some ECUs). Furthermore, in the second embodiment, a plurality of partial networks are constructed. In the in-vehicle communication system 2, a communication standard similar to that of the first embodiment (e.g., in-vehicle Ethernet) is used.

In the in-vehicle communication system 110 of the second embodiment, as an example, a first partial network and a second partial network are constructed. In the in-vehicle communication system 2 of the first embodiment, it has been possible to set the activated state or the sleep state for each node. In contrast, in the in-vehicle communication system 110 of the second embodiment, it is possible to set the activated state or the sleep state individually for each partial network.

As illustrated in FIG. 13, the in-vehicle communication system 110 includes a first node 50, a second node 60, a third node 70, a fourth node 80, a first communication line 101, a second communication line 102, and a third communication line 103. The first communication line 101 communicably connects the first node 50 and the second node 60 to each other. The second communication line 102 communicably connects the second node 60 and the fourth node 80 to each other. The third communication line 103 communicably connects the first node 50 and the third node 70 to each other.

The first node 50 is, for example, a first gateway ECU. The first node 50 is connected to, for example, a first communication system (not illustrated). The first node 50 controls transmission and reception of data between the first communication system and the in-vehicle communication system 110. A communication protocol used for communication between the first communication system and the first gateway ECU differs from a communication protocol used in the in-vehicle communication system 110. In the communication between the first communication system and the first gateway ECU, for example, CAN or CAN-FD may be used.

The second node 60 is, for example, a second gateway ECU. The second node 60 is connected to, for example, a second communication system (not illustrated). The second node 60 controls transmission and reception of data between the second communication system and the in-vehicle communication system 110. A communication protocol used for communication between the second communication system and the second gateway ECU differs from the communication protocol used in the in-vehicle communication system 110. In the communication between the second communication system and the second gateway ECU, for example, CAN or CAN-FD may be used.

The third node 70 is, for example, a body ECU, similarly to the third node 30 of the first embodiment. The fourth node 80 is, for example, a meter ECU. The meter ECU controls, for example, an instrument panel (not illustrated) installed in the vehicle 100.

The first node 50 belongs to each of a first partial network cluster (hereinafter, “first PNC”) and a second partial network cluster (hereinafter, “second PNC”). The first PNC means a group of nodes belonging to the first partial network, and the second PNC means a group of nodes belonging to the second partial network.

The hardware configuration of the first node 50 is basically the same as that of the first node 10 in the first embodiment. That is, the first node 50 includes a control unit 51, a PHY 54, and a PHY 55. The control unit 51 is connected to each of the PHY 54 and the PHY 55. The PHY 54 and the PHY 55 are connected by a connection line 58. The first node 50 includes the first transfer function for the wakeup signal. Similarly to the control unit 11 of the first node 10 in the first embodiment, the control unit 51 includes a CPU 52 and a storage section 53.

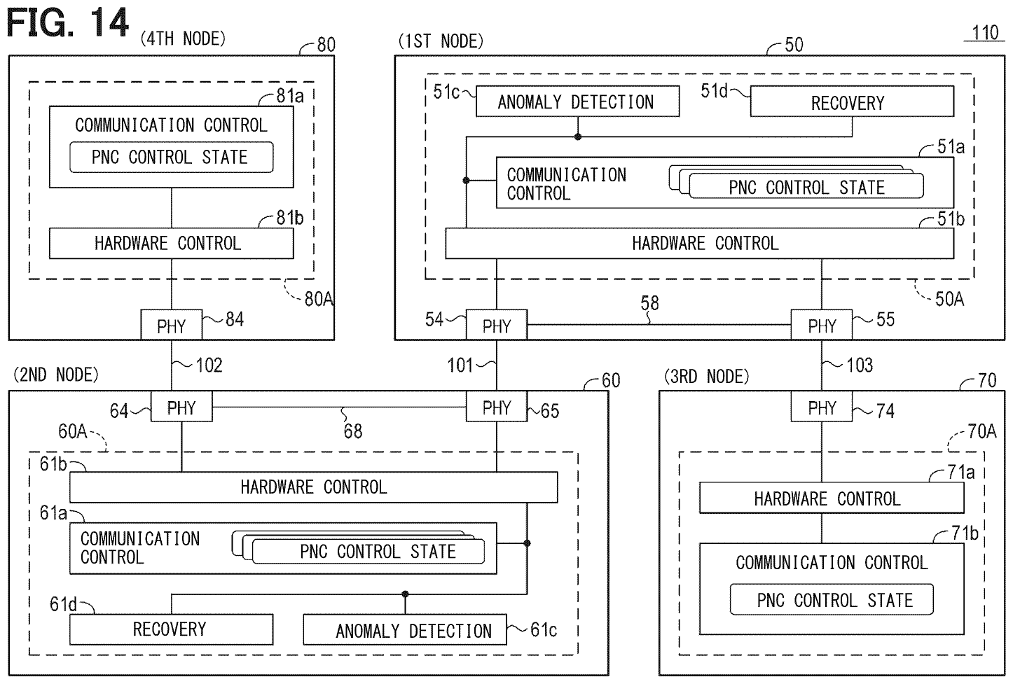

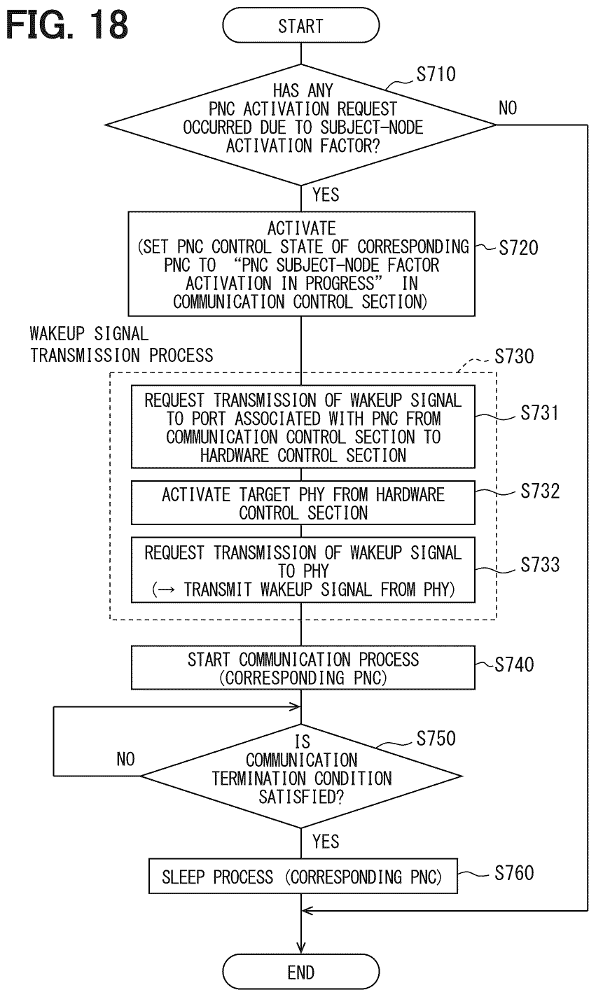

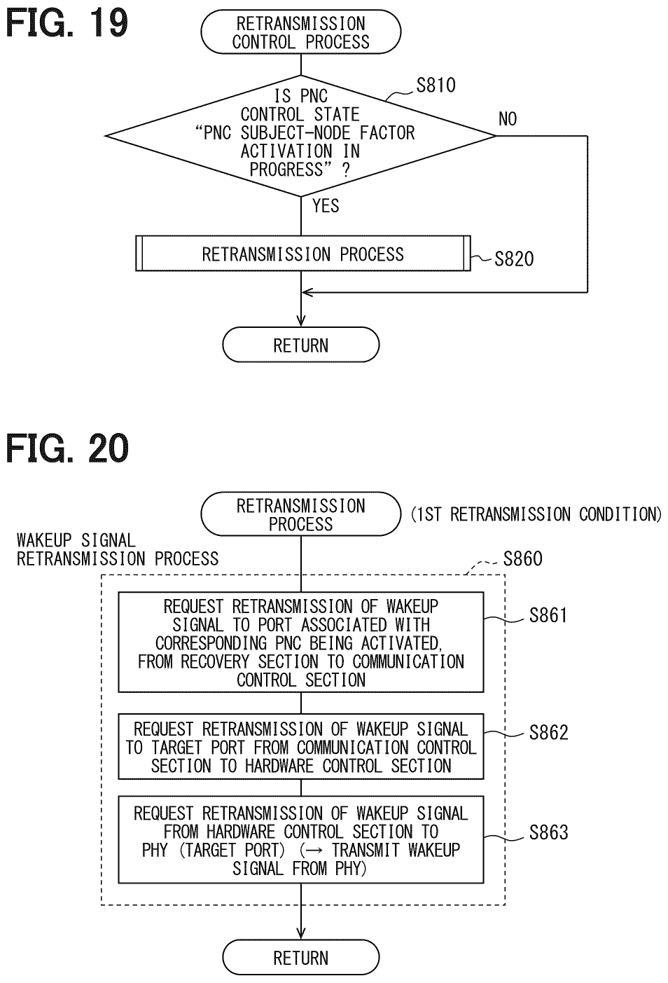

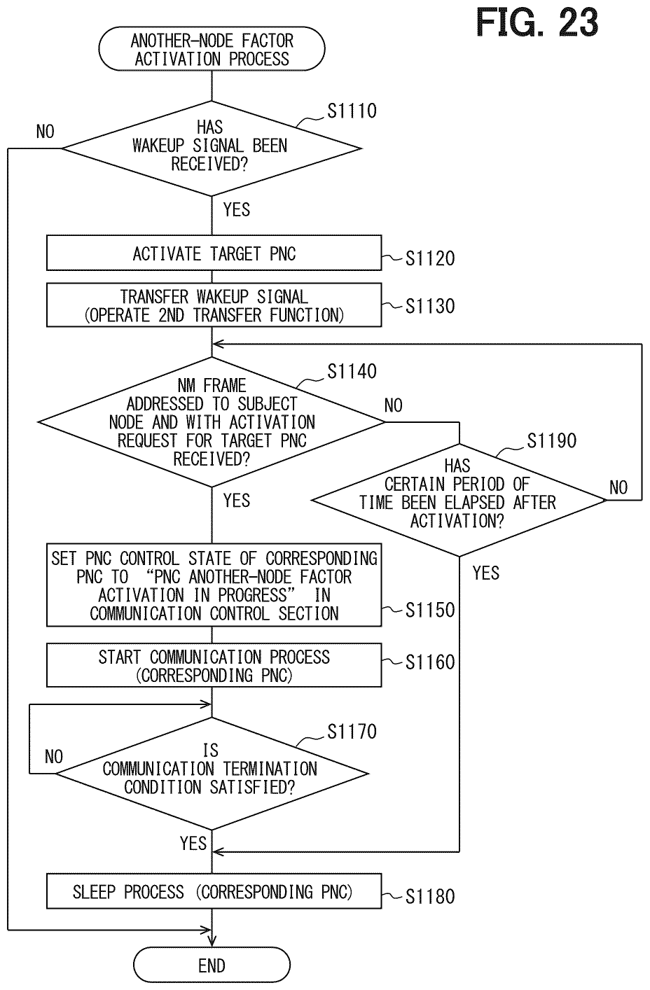

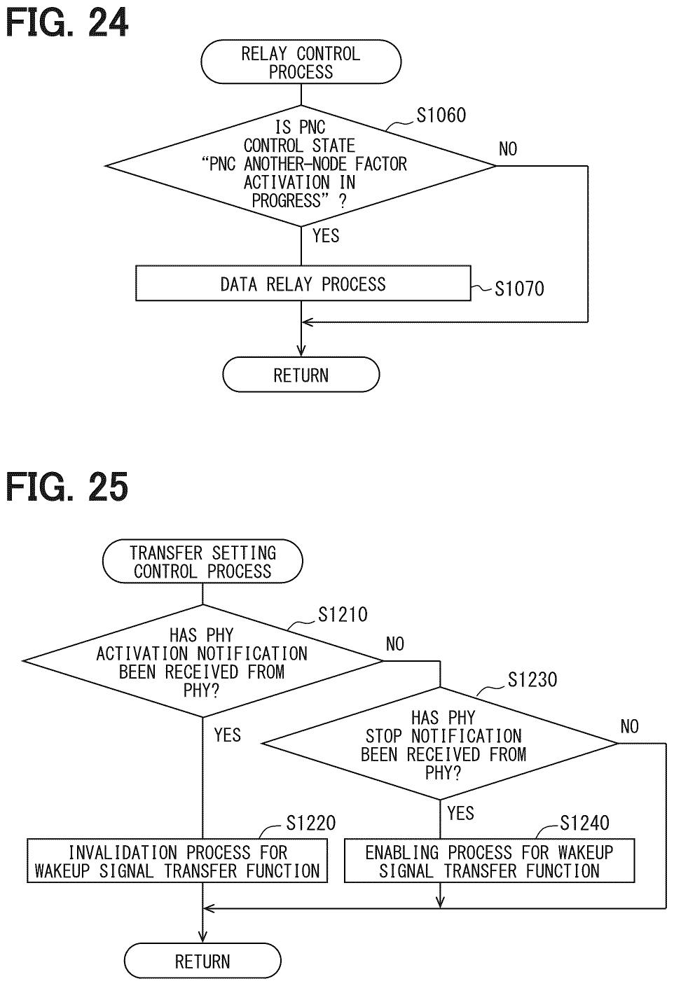

The control unit 51 includes a communication section 50A illustrated in FIG. 14. The communication section 50A is implemented by software. That is, the communication section 50A corresponds to a function implemented by the CPU 52 executing a program. The software that implements the communication section 50A includes programs for a communication control process (FIG. 18), a retransmission control process (FIG. 19), an another-node factor activation process (FIG. 23), a relay control process (FIG. 24), and a transfer setting control process (FIG. 25), which will be described later. These programs for implementing the communication section 50A are stored in the storage section 53.

The control unit 51 further includes a first node function section (not illustrated). The first node function section is responsible for an essential function as the first node 50, that is, a function as the first gateway ECU in the present example. The first node function section is implemented by software. That is, the first node function section corresponds to a function implemented by the CPU 52 executing a program.

The functions implemented by the first node function section further include a first-node first function belonging to the first PNC and a first-node second function belonging to the second PNC. In the first node 50, a subject-node activation factor occurs individually for each partial network cluster (hereinafter, “PNC”). When a subject-node activation factor occurs in the first node 50, the first node function section issues an activation request to the communication section 50A, specifying the corresponding PNC.

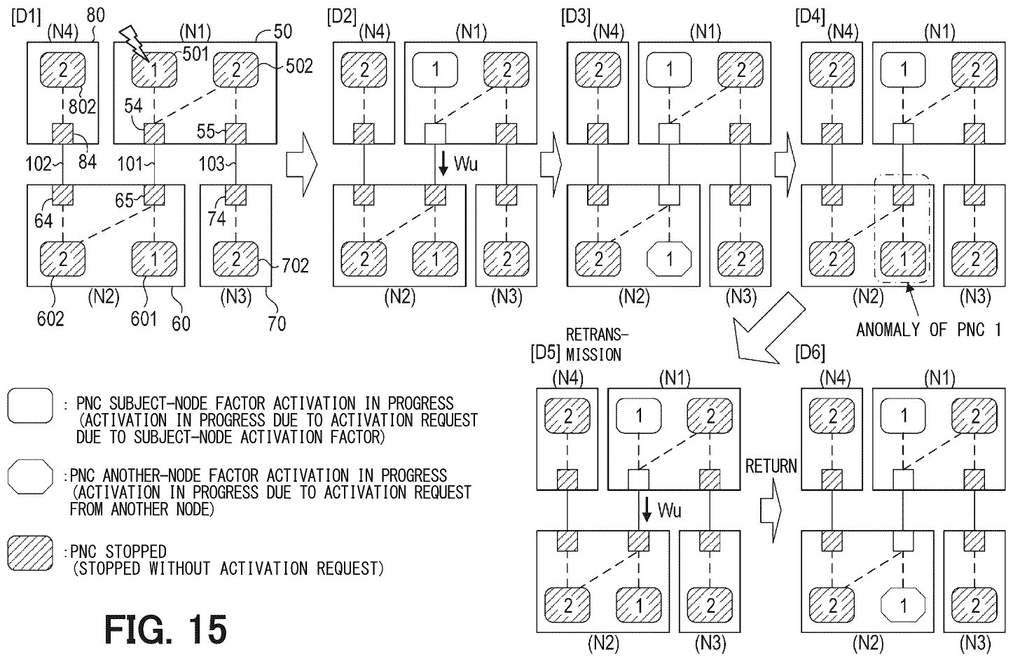

Thus, for example, when an activation factor for causing the execution of the first-node first function occurs, the communication section 50A is activated. More specifically, among the functions of the communication section 50A, the communication function corresponding to the first PNC (hereinafter, “first communication section 501”) is activated. In this case, the communication section 50A communicates with the communication target node belonging to the first PNC, and does not communicate with the communication target node not belonging to the first PNC. The first communication section 501 is illustrated in FIG. 15 to FIG. 17.

Also, for example, when an activation factor for causing the execution of the first-node second function occurs, the communication section 50A is activated. More specifically, among the functions of the communication section 50A, the communication function corresponding to the second PNC (hereinafter, “second communication section 502”) is activated. In this case, the communication section 50A communicates with the communication target node belonging to the second PNC, and does not communicate with the communication target node not belonging to the second PNC. The second communication section 502 is illustrated in FIG. 15 to FIG. 17.

The PHY 54 and the PHY 55 are configured similarly to the PHY 14 and the PHY 15 of the first node 10 in the first embodiment, respectively. The first communication line 101 is connected to the PHY 54, and the third communication line 103 is connected to the PHY 55.

The second node 60 belongs to the first PNC and the second PNC. The hardware configuration of the second node 60 is basically the same as that of the second node 20 in the first embodiment except for the number of PHYs. That is, the second node 60 includes a control unit 61, a PHY 64, and a PHY 65. The PHY 64 and the PHY 65 are connected to each other by a connection line 68. The second node 60 includes the first transfer function for the wakeup signal. The PHY 64 is connected to the second communication line 102. The PHY 65 is connected to the first communication line 101. The control unit 61 includes a CPU 62 and a storage section 63.

The control unit 61 includes a communication section 60A illustrated in FIG. 14. The communication section 60A is implemented by software. That is, the communication section 60A corresponds to a function implemented by the CPU 62 executing a program. The software that implements the communication section 60A includes programs for the communication control process (FIG. 18), the retransmission control process (FIG. 19), the another-node factor activation process (FIG. 23), the relay control process (FIG. 24), and the transfer setting control process (FIG. 25), which will be described later. These programs for implementing the communication section 60A are stored in the storage section 63.

The control unit 61 further includes a second node function section (not illustrated). The second node function section is responsible for an essential function as the second node 60, that is, a function as the second gateway ECU in the present example. The second node function section corresponds to a function implemented by the CPU 62 executing a program.

The functions implemented by the second node function section further include a second-node first function belonging to the first PNC and a second-node second function belonging to the second PNC. In the second node 60 as well, a subject-node activation factor occurs individually for each PNC. When a subject-node activation factor occurs in the second node 60, the second node function section issues an activation request to the communication section 60A, specifying the corresponding PNC.

Thus, for example, when an activation factor for causing the execution of the second-node first function occurs, the communication section 60A is activated. More specifically, among the functions of the communication section 60A, the communication function corresponding to the first PNC (hereinafter, “first communication section 601”) is activated. In this case, the communication section 60A communicates with the communication target node belonging to the first PNC, and does not communicate with the communication target node not belonging to the first PNC. The first communication section 601 is illustrated in FIG. 15 to FIG. 17.

Also, for example, when an activation factor for causing the execution of the second-node second function occurs, the communication section 60A is activated. More specifically, among the functions of the communication section 60A, the communication function corresponding to the second PNC (hereinafter, “second communication section 602”) is activated. In this case, the communication section 60A communicates with the communication target node belonging to the second PNC, and does not communicate with the communication target node not belonging to the second PNC. The second communication section 602 is illustrated in FIG. 15 to FIG. 17.

For example, the third node 70 belongs to the second PNC and does not belong to the first PNC. The hardware configuration of the third node 70 is basically the same as that of the third node 30 of the first embodiment. That is, the third node 70 includes a control unit 71 and a PHY 74. The PHY 74 is connected to the third communication line 103. The control unit 71 includes a CPU 72 and a storage section 73.

The control unit 71 includes a communication section 70A illustrated in FIG. 14. The communication section 70A is implemented by software. That is, the communication section 70A corresponds to a function implemented by the CPU 72 executing a program. The software that implements the communication section 70A includes programs for the communication control process (FIG. 18) and the another-node factor activation process (FIG. 23), which will be described later. These programs for implementing the communication section 70A are stored in the storage section 73.

The control unit 71 further includes a third node function section (not illustrated). The third node function section is responsible for an essential function as the third node 70, that is, a function as a body ECU in the present example. In the present embodiment, the third node function section is responsible for a function belonging to the second PNC. The third node function section corresponds to a function implemented by the CPU 72 executing a program.

In the third node 70 as described above, when a subject-node activation factor occurs in the third node 70, that is, when a subject-node activation factor for causing the execution of the function of the third node function section occurs, an activation request is issued to the communication section 70A, specifying the second PNC.

The communication section 70A that has received the activation request activates the communication function corresponding to the second PNC (hereinafter, “second communication section 702”). In this case, the communication section 70A communicates with the communication target node belonging to the second PNC, and does not communicate with the communication target node not belonging to the second PNC. The second communication section 702 is illustrated in FIG. 15 to FIG. 17.

For example, the fourth node 80 belongs to the second PNC and does not belong to the first PNC. The hardware configuration of the fourth node 80 is basically the same as that of the third node 70. That is, the fourth node 80 includes a control unit 81 and a PHY 84. The PHY 84 is connected to the second communication line 102. The control unit 81 includes a CPU 82 and a storage section 83.

In addition, the control unit 81 includes a communication section 80A illustrated in FIG. 14. The communication section 80A is implemented by software. That is, the communication section 80A corresponds to a function implemented by the CPU 82 executing a program. The software that implements the communication section 80A includes programs for the communication control process (FIG. 18) and the another-node factor activation process (FIG. 23), which will be described later. These programs for implementing the communication section 80A are stored in the storage section 83.

The control unit 81 further includes a fourth node function section (not illustrated). The fourth node function section is responsible for an essential function as the fourth node 80, that is, a function as a meter ECU in the present example. In the present embodiment, the fourth node function section is responsible for a function belonging to the second PNC. The fourth node function section corresponds to a function implemented by the CPU 82 executing a program.

In the fourth node 80 as described above, when a subject-node activation factor occurs in the fourth node 80, that is, when a subject-node activation factor for causing the execution of the function of the fourth node function section occurs, an activation request is issued to the communication section 80A, specifying the second PNC.

The communication section 80A that has received the activation request activates the communication function corresponding to the second PNC (hereinafter, “second communication section 802”). In this case, the communication section 80A communicates with the communication target node belonging to the second PNC, and does not communicate with the communication target node not belonging to the second PNC. The second communication section 802 is illustrated in FIG. 15 to FIG. 17.

### (2-2) Specific Configuration of In-Vehicle Communication System

A communication function in the in-vehicle communication system 110 of the second embodiment will be described more specifically with reference to FIG. 14. As illustrated in FIG. 14, the first node 50 includes the communication section 50A described above. Similarly to the communication section 50A of the first embodiment, the communication section 10A includes a communication control section 51a, a hardware control section 51b, an anomaly detection section 51c, and a recovery section 51d. The communication section 50A basically includes functions equivalent to those of the communication section 10A (cf. FIG. 2) in the first embodiment, except that those functions are controlled individually for each PNC.

That is, the communication control section 51a sets the NM control state of the communication section 50A individually for each PNC to which the node belongs. Therefore, in the present embodiment, the NM control state is referred to as a PNC control state. The PNC control state is set individually for each PNC to which the node belongs. In the present embodiment, the PNC control state can be set to any one of the following states: “PNC subject-node factor activation in progress”, “PNC another-node factor activation in progress”, and “PNC stopped”.

The above “PNC stopped” corresponds to the communication function of the corresponding PNC being in the sleep state. In the first node 50, the first communication section 501 corresponding to the first PNC and the second communication section 502 corresponding to the second PNC are activated individually. Therefore, “PNC stopped” is also set individually in the first communication section 501 and the second communication section 502.

Both “PNC subject-node factor activation in progress” and “PNC another-node factor activation in progress” correspond to the activated state of the communication function of the corresponding PNC.

The above “PNC subject-node factor activation in progress” is set for the PNC specifically when the communication control section 51a receives an activation request from the first node function section due to the occurrence of a subject-node activation factor corresponding to a certain PNC and is activated. The above “PNC another-node factor activation in progress” is set for the PNC by receiving the wakeup signal from another node during the sleep state and further receiving information indicating the PNC to be activated.

When activated by a subject-node activation factor corresponding to a certain PNC, the communication control section 51a transmits the wakeup signal from a port to which a communication target node belonging to the PNC is connected. Thus, the communication target node not belonging to the PNC is not activated.

The entity of each of the first communication section 501 and the second communication section 502 is software, and the difference therebetween lies in the corresponding PNC. The same applies to the first communication section 601 and the second communication section 602 of the second node 60.

Next, the second node 60 includes the communication section 60A described above, which is implemented by software. The communication section 60A includes a communication control section 61a, a hardware control section 61b, an anomaly detection section 61c, and a recovery section 61d. These sections include functions equivalent to those of the communication section 20A (cf. FIG. 2) in the first embodiment, except that the sections are controlled individually for each PNC and two ports are provided. In the second node 60, as described above, the first communication section 601 corresponding to the first PNC and the second communication section 602 corresponding to the second PNC are activated individually.

Next, the third node 70 includes the communication section 70A described above, which is implemented by software. The communication section 70A includes a communication control section 71a and a hardware control section 71b. These sections basically include functions equivalent to those of the communication section 30A (cf. FIG. 2) in the first embodiment, except that the sections are controlled individually for each PNC to which the node belongs. In the third node 70, as described above, the second communication section 702 corresponding to the second PNC is activated.

Next, the fourth node 80 includes the communication section 80A described above, which is implemented by software. The communication section 80A includes a communication control section 81a and a hardware control section 81b. These sections include functions equivalent to those of the communication control section 71a and the hardware control section 71b of the third node 70. In the fourth node 80, as described above, the second communication section 802 corresponding to the second PNC is activated individually.

### (2-3) Operation Example of In-Vehicle Communication System

Next, an operation example of the in-vehicle communication system 110 of the second embodiment will be described with reference to FIG. 15 to FIG. 17. FIG. 15 to FIG. 17 all assume that, for example, at least one of the second or third retransmission condition is adopted as the retransmission condition.

First, an operation example illustrated in FIG. 15 will be described. In FIG. 15, state D1 indicates a state in which all of the first to fourth nodes 50 to 80 are in the sleep state. Specifically, in the first node 50, the first communication section 501 and the second communication section 502 are set to “PNC stopped”, and the PHYs 54, 55 are also set to “stopped” (i.e., sleep state). In the second node 60 as well, the first communication section 601 and the second communication section 602 are set to “PNC stopped”, and the PHYs 64, 65 are set to “stopped”. The second communication section 702 of the third node 70 and the second communication section 802 of the fourth node 80 are also set to “PNC stopped”, and the PHY 74 and the PHY 84 are also set to “stopped”.

In state D1, when a subject-node activation factor corresponding to the first PNC occurs in the first node 50, the first communication section 501 is activated (cf. state D2). Specifically, in the communication control section 51a, the PNC control state corresponding to the first PNC is set to “PNC subject-node factor activation in progress”. The PHY 54 connected to the second node 60 is also activated. Since the third node 70 does not belong to the first PNC, the PHY 55, the PHY 74, and the second communication section 702 are not activated. In addition, since only the subject-node activation factor corresponding to the first PNC has occurred, the second communication section 502 of the first node 50 is also not activated.

The first communication section 501 transmits the wakeup signal from the PHY 54 to the second node 60.

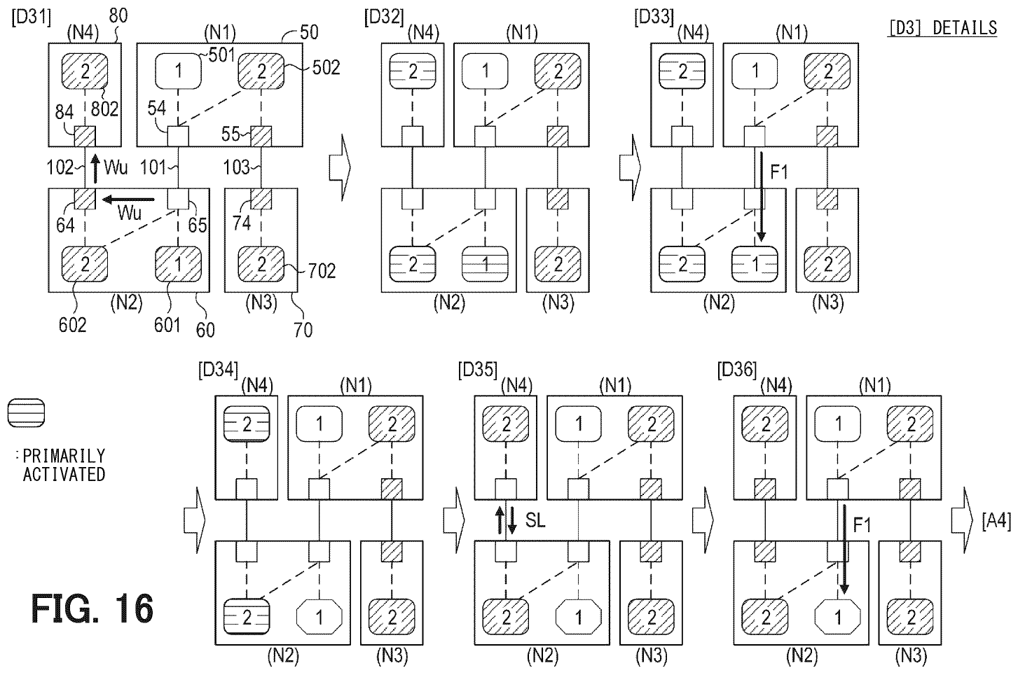

In the second node 60, when the wakeup signal is received from the first node 50, the PHY 65 is activated and the first communication section 601 is activated (cf. state D3). More specifically, the transition from state D2 to state D3 undergoes a process as illustrated in FIG. 16.

That is, when the PHY 54 of the second node 60 receives the wakeup signal transmitted from the PHY 65 of the first node 50, the PHY 65 is activated. Thus, by the first transfer function for the wakeup signal, the wakeup signal is transferred from the PHY 65 to the fourth node 80 through the PHY 64 (state D31). At this time, the PHY 64 and the PHY 84 are activated upon receiving the transferred wakeup signal (state D32). Once the wakeup signal is received, the first communication section 601 and the second communication section 602 of the second node and the second communication section 802 of the fourth node 80 are also activated temporarily (state D32).

On the other hand, the first communication section 501 that has transmitted the wakeup signal transmits an NM frame F1 corresponding to the first PNC to the second node 60 (state D33). The NM frame F1 includes first identification information indicating the first PNC. Therefore, the first communication section 601 of the second node 60 holds the activated state based on the NM frame (state D34). When the second communication section 502 transmits an NM frame corresponding to the second PNC to another node, the NM frame includes second identification information indicating the second PNC.

On the other hand, the second communication section 602 of the second node 60 and the second communication section 802 of the fourth node transition back to the sleep state in response to the NM frame corresponding to the second PNC not being received for a certain period of time or longer after the activation (state D35). As in the first embodiment, the NM frame is regularly transmitted during communication (state D36). In this manner, the transition to state D3 in FIG. 15 is performed through the above process illustrated in FIG. 16 in more detail.

Returning to FIG. 15, the description will be continued. For example, when the first detection method described above is adopted in the anomaly detection section 51c, a prescribed command is periodically transmitted from the first node 50 to the second node 60. In addition, for example, when the second detection method described above is adopted, the link down of the port (PHY 65) is monitored. In addition, for example, when the third detection method described above is adopted, a periodic message is periodically transmitted from the second node 60 to the first node 50.

For example, it is assumed that the first communication section 601 of the second node 60 enters the anomalous communication state after the transition to state D3. In this case, the first communication section 601 of the second node 60 transitions to the sleep state (cf. state D4). More specifically, when the first communication section 601 of the second node 60 enters the anomalous communication state, the first communication section 601 transitions to “PNC stopped” and the PHY 65 transitions to “stopped”.

The anomaly detection section 51c of the first node 50 detects that the first communication section 601 has entered the anomalous communication state. As a result, the retransmission condition is satisfied in the first node 50. Therefore, the wakeup signal is retransmitted from the first node 50 to the second node 60 (cf. state D5).

Upon receiving the wakeup signal retransmitted from the first node 50, the first communication section 601 of the second node 60 that has transitioned to the sleep state due to the occurrence of the anomalous communication state is reactivated (cf. state D6). This enables the first communication section 501 of the first node 50 to resume communication corresponding to the first PNC with the first communication section 601 of the second node 60.

In the operation example of FIG. 15, if the retransmission condition includes the first retransmission condition, when communication between the first node 50 and the second node 60 is started (cf. state D3), the wakeup signal is periodically retransmitted from the first node 50 to the second node 60. Therefore, even if the first communication section 601 of the second node 60 enters the anomalous communication state, the first communication section 601 can be reactivated by receiving the wakeup signal retransmitted from the first node 50.

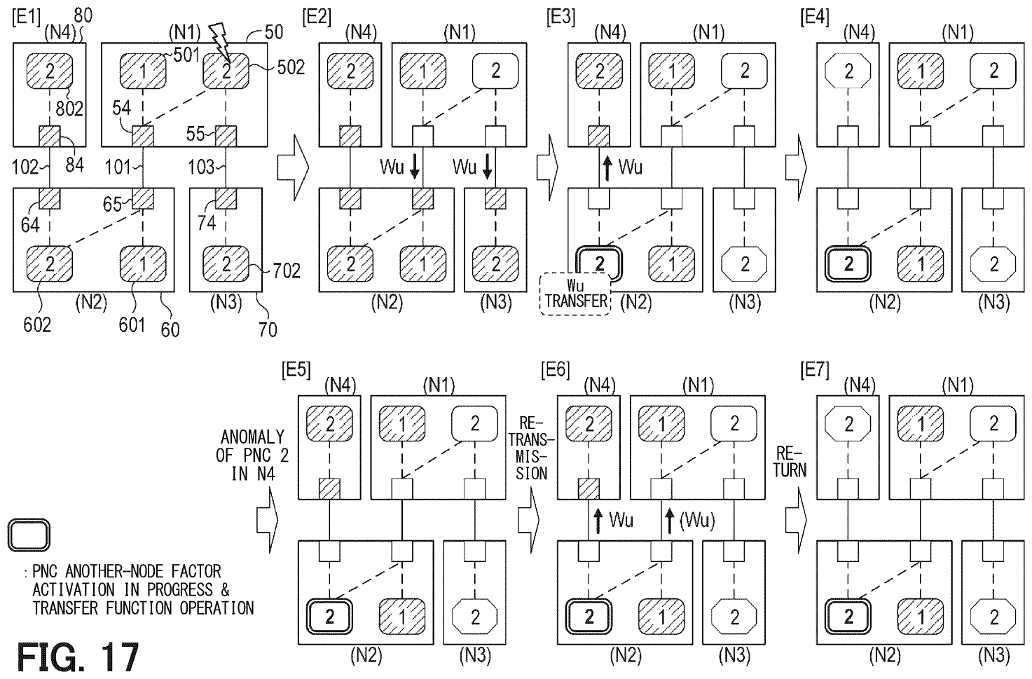

Next, an operation example illustrated in FIG. 17 will be described. FIG. 17 illustrates an operation example in which data corresponding to the second PNC addressed from the first node 50 to the fourth node 80 is relayed by the second communication section 602 of the second node 60.

In FIG. 17, state E1 is the same as state D1 in FIG. 15. In state E1, when a subject-node activation factor corresponding to the second PNC occurs in the first node 50, the second communication section 502 is activated (cf. state E2). Specifically, the communication section 50A of the first node 50 is activated, and the PNC control state corresponding to the second PNC is set to “PNC subject-node factor activation in progress” in the communication control section 51a. Both the PHYs 54, 55 are activated by being connected to the communication target node belonging to the second PNC.

The activated second communication section 502 transmits the wakeup signal from each port to which the communication target node is connected (state E2). This activates the second communication section 602 of the second node 60 and the second communication section 702 of the third node 70 (state E3). Furthermore, by the first transfer function for the wakeup signal, the wakeup signal is transferred to the fourth node 80, thereby activating the fourth node 80 (state E4). In addition to the first transfer function or instead of the first transfer function, the wakeup signal may be transferred by the second transfer function by software processing.

In state E4, the second communication section 602 of the second node 60 relays communication corresponding to the second PNC between the second communication section 502 of the first node 50 and the second communication section 802 of the fourth node. Moreover, the second communication section 602 of the second node 60 determines whether the retransmission condition is satisfied for the fourth node 80 as the relay destination. At this time, for example, when the retransmission condition is satisfied due to the second communication section 802 of the fourth node 80 entering the anomalous communication state (cf. state E5), the second communication section 602 of the second node 60 retransmits the wakeup signal to the fourth node 80 (cf. state E6). As a result, the fourth node 80 is reactivated (cf. state E7).

In the operation example of FIG. 17, if the retransmission condition includes the first retransmission condition, the wakeup signal is periodically retransmitted from the second communication section 602 of the second node 60 to each of the first node 50 and the fourth node 80 in state E4. This is because both the first node 50 and the fourth node 80 belong to the second PNC. Therefore, even if the second communication section 502 of the first node 50 enters the anomalous communication state in which communicate with another node cannot be performed, the second communication section 502 can be reactivated upon receiving the wakeup signal retransmitted from the second node 60.

The second communication section 502 of the first node 50 may transfer the wakeup signal retransmitted from the second communication section 602 of the second node 60 to the third node 70 belonging to the second PNC. In addition, the second communication section 502 of the first node 50 may not transfer the wakeup signal retransmitted from the second communication section 602 of the second node 60 to the third node 70 belonging to the second PNC, based on a predetermined condition. The predetermined condition includes, for example, a case where an anomaly has occurred in the third node 70 and/or a case where communication is congested.

### (2-4) Various Processes by Communication Section

Next, the communication control process executed by the first node 50 to implement the various functions described above will be described with reference to FIG. 18. The communication control process according to the second embodiment corresponds to a process by the communication section 50A. The CPU 52 of the first node 50 starts operating as the communication section 50A upon receiving electric power supply and starting operation. The operation of the communication section 50A includes periodically and repeatedly executing the communication control process of FIG. 18.

Upon starting the operation, the communication section 50A (specifically, the CPU 52) of the first node 50 transitions itself and each of the PHYs 54, 55 to the sleep state and starts the communication control process.

Upon starting the communication control process, the communication section 50A determines in S710 whether any PNC activation request due to the subject-node activation factor (i.e., an activation request from the first node function section) has occurred. When the activation request due to the subject-node activation factor has not occurred, the communication section 50A terminates the present process. When the activation request due to the subject-node activation factor has occurred, the communication section 50A activates one of the first communication section 501 or the second communication section 502 corresponding to the PNC for which the subject-node activation factor has occurred in S720. For example, when the communication section 50A receives the activation request due to the occurrence of the subject-node activation factor corresponding to the second PNC, the PNC control state of the second PNC is set to “PNC subject-node factor activation in progress” based on the information of the PNC included in the activation request. More specifically, the process of S730 after any PNC is activated in S720 is executed by one of the first communication section 501 or the second communication section 502 corresponding to the activated PNC. The activation request may be received from both the first PNC and the second PNC. In this case, more specifically, the processes in and after S730 are executed by each of the first communication section 501 and the second communication section 502.

In step S730, the communication section 50A executes the wakeup signal transmission process. Specifically, first, in S731, the communication section 50A requests the hardware control section 51b from the communication control section 51a to transmit the wakeup signal from the port associated with the corresponding PNC (i.e., the PNC of the occurrence source of the subject-node activation factor). Next, in S732, the hardware control section 51b that has received the request activates the PHY of the corresponding port. Furthermore, in S733, the PHY of the corresponding port is requested to transmit the wakeup signal. As a result, the wakeup signal is transmitted from the corresponding PHY. That is, the wakeup signal is transmitted only to the communication target node belonging to the PNC that has caused the activation.

After the wakeup signal is transmitted, the communication section 50A starts a communication process in S740. This communication process is the same as the communication process of S140 (FIG. 6) in the first embodiment, except that the communication target is a node belonging to the corresponding PNC.

In S750, the communication section 50A determines whether the communication termination condition is satisfied. When the communication termination condition is not satisfied, the communication section 50A repeats the determination process of S740 while continuing the communication process. The determination process of S740 may be repeated at any cycle. The determination process of S740 may be performed aperiodically. The communication termination condition may be determined in any manner. In the present embodiment, when communication becomes unnecessary, the upper layer of each PNC notifies the communication control section 51a of that fact. Therefore, the communication termination condition may be satisfied, for example, when the communication unnecessity is notified from the upper layer of the PNC being activated. In addition, for example, the communication termination condition may be satisfied when a state in which no data is transmitted to or received from the communication target node continues for a predetermined period of time.

When the communication termination condition is satisfied in S150, the process proceeds to S760. In S760, the communication section 50A terminates the communication with the communication target node where the communication termination condition is satisfied, and shifts the communication section of the corresponding PNC to the sleep state.

The communication control process of FIG. 18 is similarly performed in the second to fourth nodes 60 to 80.

Next, the retransmission control process will be described with reference to FIG. 19. The retransmission control process is executed (i) when activation occurs due to the subject-node activation factor, and (ii) after the communication process of S740 is started in the communication control process of FIG. 18. Here, as an example, a description will be given assuming that the retransmission control process is executed in the first node 50. The retransmission control process is periodically and repeatedly executed during the activation of the communication section 50A.

Upon starting the retransmission control process, in S810, the communication section 50A of the first node 50 determines whether the PNC control state of any PNC within itself is “PNC subject-node factor activation in progress”. The state of any PNC being “PNC subject-node factor activation in progress” indicates that the upper layer corresponding to the PNC requires communication in the PNC. When the state of any PNC is not “PNC subject-node factor activation in progress”, the communication section 50A terminates the present process. When the state of any PNC is “PNC subject-node factor activation in progress”, the communication section 50A executes the retransmission process in S820.

For example, when the retransmission condition includes the first retransmission condition, the retransmission process of FIG. 20 is executed. Upon starting the retransmission process of FIG. 20, the communication section 50A executes the wakeup signal retransmission process in S860. Specifically, in S861, the communication section 50A first requests the communication control section 51a from the recovery section 51d to transmit the wakeup signal from the port associated with the corresponding PNC being activated. The wakeup signal is transmitted from the target port by the processes after S862. Since the processes of S862 to S863 are basically equivalent to those of S262 to S263 of FIG. 8, a detailed description thereof will be omitted.

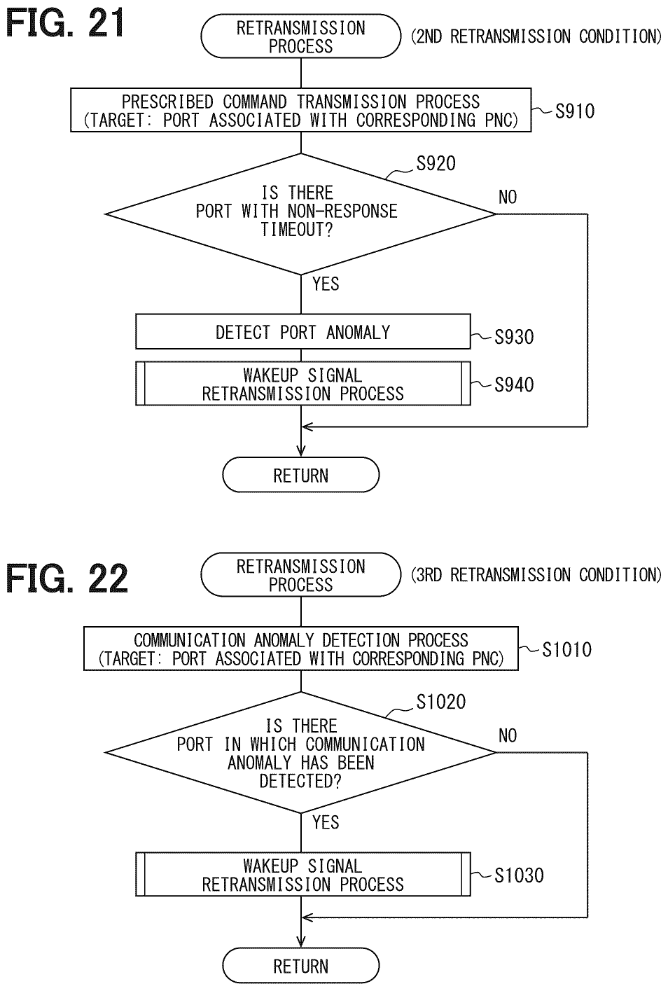

Next, FIG. 21 illustrates the retransmission process. The retransmission process is executed when the retransmission condition includes the second retransmission condition. Upon starting the retransmission process of FIG. 21, the communication section 50A transmits a prescribed command from the port connected to the communication target node belonging to the corresponding PNC to the communication target node in S910. The present process is performed by the anomaly detection section 51c. The prescribed command transmitted here includes information on the corresponding PNC.

In S920, the communication section 50A determines whether a non-response timeout has occurred in any of the ports that have transmitted the prescribed command. That is, the communication section 50A determines whether there is a port that does not properly receive response data to the prescribed command.

When there is no port in which the non-response timeout has occurred, the communication section 50A terminates the present process. On the other hand, when there is a port in which the non-response timeout has occurred, the communication section 50A performs port anomaly detection in S930. The present process is performed by the anomaly detection section 51c. Specifically, the anomaly detection section 51c notifies the recovery section 51d of the occurrence of the anomaly, the response PNC, and the corresponding port.

In step S940, the communication section 50A executes a wakeup signal retransmission process. The wakeup signal retransmission process of S940 is the same as the wakeup signal retransmission process of S860 in FIG. 20, except that the retransmission target port is only the port in which the non-response timeout has occurred.

Next, FIG. 22 illustrates the retransmission process executed when the third retransmission condition is adopted as the retransmission condition. Upon starting the retransmission process of FIG. 22, the communication section 50A executes the communication anomaly detection process in S1010. Specifically, the communication section 50A detects the anomalous communication state of the communication target node by using the second detection method and/or the third detection method described above. The process target of S1010 is a port associated with the corresponding PNC.

In S1020, the communication section 50A determines whether there is a port for which the anomalous communication state has been detected by the process of S1010. When there is a port for which the anomalous communication state has been detected, the communication section 50A executes a wakeup signal retransmission process in S1030. The wakeup signal retransmission process of S1030 is the same as the wakeup signal retransmission process of S860 in FIG. 20, except that the retransmission target port is only the port for which the anomalous communication state has been detected.

Next, an another-node factor activation process according to the second embodiment will be described with reference to FIG. 23. In the second embodiment, all of the first to fourth nodes 50 to 80 can execute the another-node factor activation process. The another-node factor activation process is further executed individually for each PNC. That is, for example, in the first node 50, the another-node factor activation process is executed for each of the first PNC and the second PNC.

Upon starting the operation, the communication section 50A transitions itself and the PHYs 54, 55 to the sleep state as described above and starts the another-node factor activation process. The communication section 50A may execute the another-node factor activation process in parallel with the communication control process described above (cf. FIG. 18), for example.

Upon starting the another-node factor activation process, the communication section 50A determines whether the wakeup signal has been received from another node in S1110. When the wakeup signal is not received from another node, the communication section 50A terminates the present process. When the wakeup signal is received from another node, the communication section 50A activates the target PNC in S1120. In S1130, the communication section 50A transfers the wakeup signal to a port other than the port from which the wakeup signal has been received in S1110. That is, in S1130, the communication section 50A activates the second transfer function.

In S1140, the communication section 50A determines whether an NM frame addressed to the subject node and requesting the activation of the target PNC has been received at the port that has been activated after receiving the wakeup signal. When the corresponding NM frame has not been received, the communication section 50A determines in S1180 whether a certain period of time has elapsed since the activation of the communication section of the target PNC. When the certain period of time has not elapsed, the process returns to S1140. When the certain period of time has elapsed, the communication section 50A shifts the communication section of the target PNC in the first node 50 to the sleep state in S1170. That is, the communication control section 51a sets the PNC control state of the target PNC to “PNC stopped” and shifts the communication section of the target PNC to the sleep state. Furthermore, when the communication sections of all the other PNCs are in the sleep state, the PHY being activated is also shifted to the sleep state.

When the corresponding NM frame is received in S1140, the communication section 50A sets the PNC control state of the target PNC in the communication control section 51a to “PNC another-node factor activation in progress” in S1150. In S1160, the communication section 50A starts the communication process. The communication process of S1160 is basically the same as the communication process of S740 in FIG. 18, and communication is performed within the range of the target PNC.

In S1170, the communication section 50A determines whether the communication termination condition is satisfied. When the communication termination condition is not satisfied, the communication section 50A repeats the determination process of S1170 while continuing the communication process. The determination process of S1170 may be repeated at any cycle. The determination process of S1170 may be performed aperiodically. The communication termination condition in S1170 may be determined in any manner. The communication termination condition may be satisfied when a state in which no data is transmitted to or received from the communication target node continues for a predetermined period of time.

When the communication termination condition is satisfied in S1170, the communication section 50A terminates the communication with the communication target node where the communication termination condition is satisfied and shifts the communication section of the target PNC to the sleep state in S1180.

Next, the relay control process will be described with reference to FIG. 24. This relay control process is executed when the communication section 60A of the second node 60 is activated by the another-node factor activation process of FIG. 23. Upon starting the communication process of S1160 in the another-node factor activation process of FIG. 23, the communication section 60A executes the relay control process of FIG. 24 in parallel.

Upon starting the relay control process, the communication section 60A determines in S1060 whether the PNC control state of the PNC activated by the wakeup signal from another node is “PNC another-node factor activation in progress”. When the PNC control state is “PNC another-node factor activation in progress”, the communication section 60A executes the data relay process in S1070. Specifically, the communication section 60A executes the data relay function described above. The data relay function relays communication within the range of the corresponding PNC between another node, which is the transmission source of the wakeup signal that has caused its own activation, and a node different from that other node. The data relay function further includes the retransmission control of the wakeup signal for the corresponding PNC in the relay destination node. Therefore, in S1070, a retransmission process similar to that in S820 in FIG. 19 is also performed for the relay destination node.

Next, the transfer setting control process will be described with reference to FIG. 25. The transfer setting control process is executed in a node including the first transfer function by hardware of the wakeup signal. The transfer setting control process temporarily disables the first transfer function for the wakeup signal when the node including the first transfer function receives the wakeup signal from another node. This transfer setting control process is particularly effective when the first retransmission condition is included in the retransmission condition of the retransmission process in the transmission source node of the wakeup signal.

That is, the node adopting the first retransmission condition is activated by the subject-node activation factor, transmits the wakeup signal, and then periodically and repeatedly retransmits the wakeup signal. Therefore, for example, it is assumed that the first PNC is activated in the first node 50, and the wakeup signal is repeatedly retransmitted from the first node 50 to the PHY 65 of the second node 60. In this case, each time the wakeup signal is retransmitted, the wakeup signal is transferred to the fourth node 80 through the PHY 64. Although the fourth node 80 does not belong to the first PNC and does not need to be activated, the fourth node 80 is forced to be activated by the wakeup signal transferred by the first transfer function.

In contrast, when the node including the first transfer function executes the transfer setting control process of FIG. 25, it is possible to avoid activation of a node that does not need to be activated (specifically, a PNC that does not need to be activated) as described above.

As an example, a description will be given assuming that the communication section 60A of the second node 60 executes the transfer setting control process. The transfer setting control process is repeatedly executed at a predetermined cycle.

Upon starting the transfer setting control process, the communication section 60A determines in S1210 whether a PHY activation notification has been received from any of the PHYs 64, 65 in the second node 60. Upon receiving the wakeup signal during sleep, the PHY of the present embodiment is activated and transmits the PHY activation notification to the communication section 60A (specifically, to the hardware control section 61b). That is, the PHY activation notification notifies that the PHY has received the wakeup signal.

When the PHY activation notification is received, the communication section 60A performs an invalidation process on the first transfer function for the wakeup signal in S1220. Specifically, the communication section 60A causes the PHY that has transmitted the PHY activation notification to stop transfer of the wakeup signal from the PHY to another PHY. As a result, even if the wakeup signal is periodically received by the PHY thereafter, the wakeup signal is prevented from being transferred.

When the PHY activation notification has not been received in S1210, the communication section 60A determines whether a PHY stop notification has been received from any PHY in S1230. When transitioning to the sleep state, the PHY of the present embodiment transmits a PHY stop notification to the hardware control section 61b. That is, the PHY stop notification notifies that the PHY is entering the sleep state.

When the PHY stop notification is received, the communication section 60A performs an enabling process for the first transfer function for the wakeup signal in S1240. Specifically, the communication section 60A causes the PHY that has transmitted the PHY stop notification to transfer the wakeup signal received by the PHY to another PHY.

### 3. Other Embodiments

Although the embodiments of the present disclosure have been described above, the present disclosure is not limited to the above embodiments, and various modifications can be made.

(3-1) In the first embodiment, an in-vehicle communication system including three nodes has been exemplified, and in the second embodiment, an in-vehicle communication system including four nodes and in which a plurality of partial networks are constructed has been exemplified. However, the in-vehicle communication system may include any number of nodes, and any number of partial networks may be constructed in the in-vehicle communication system.

In the in-vehicle communication system, a plurality of nodes may be connected to each other in any way. Each of the plurality of nodes may include any number of PHYs. In addition, some or all of the plurality of nodes may include the retransmission function for the wakeup signal in the present disclosure.

The node including the plurality of PHYs does not necessarily include the first transfer function for the wakeup signal by hardware. The node including the plurality of PHYs does not necessarily include a data transfer function by software (including a retransmission function of a wakeup signal to a transfer destination node).

(3-2) In the first embodiment, the first node 10 includes a function of relaying data communication between the second node 20 and the third node 30. A plurality of nodes including such a relay function may be connected in multiple stages, whereby data may be relayed via the plurality of nodes.

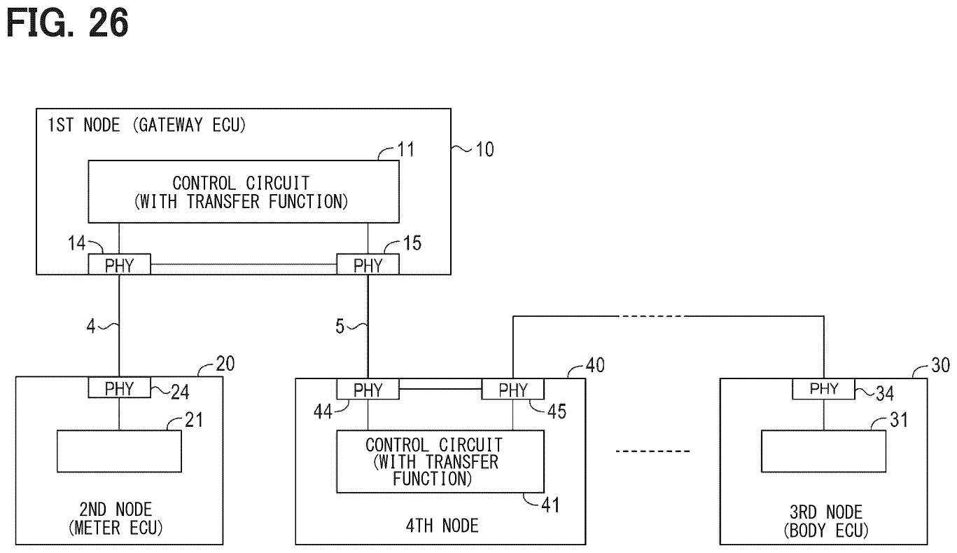

For example, in the in-vehicle communication system illustrated in FIG. 26, one or more additional nodes including a fourth node 40 are connected between the first node 10 and the third node 30, compared to the first embodiment illustrated in FIG. 1. Each of the one or more additional nodes includes a data relay function. For example, the fourth node includes a control circuit 41, a PHY44, and a PHY45. The control circuit 41 includes a function of relaying data communication between a node connected to the PHY44 and a node connected to the PHY45. This enables the second node 20 to perform data communication with the third node 30 by relaying the first node 10 and the one or more additional nodes.

Each of the one or more additional nodes, including the fourth node 40 (i) includes a retransmission function for the wakeup signal, and (ii) can retransmit the wakeup signal to the transfer destination node and reactivate the node when detecting the anomalous communication state of the node.

The multi-stage relay as described above can also be adopted in the second embodiment. For example, in the configuration illustrated in FIG. 13, one or more additional nodes may be connected in multiple stages between the second node and the fourth node. The wakeup signal from the second node may be transmitted to the fourth node by sequentially relaying the one or more additional nodes.

(3-3) In the first embodiment, the communication section 10A transmits the wakeup signal upon activation by a subject-node activation factor. After the transmission, the wakeup signal is transmitted (i.e., retransmitted) when the retransmission condition is satisfied. However, the communication section 10A may not unconditionally transmit the wakeup signal when activated due to the subject-node activation factor. That is, after being activated by the subject-node activation factor, the communication section 10A may wait to transmit the wakeup signal until the retransmission condition is satisfied. The communication section 10A may transmit the wakeup signal in response to, the satisfaction of the retransmission condition. The same applies to the other communication sections 20A, 30A, and the same applies to the communication section 50A, the communication section 60A, the communication section 70A, and the communication section 80A of the second embodiment.

(3-4) The present disclosure is not limited to application to communication between a plurality of ECUs. That is, the node constituting the in-vehicle communication system is not limited to the ECU. The present disclosure is applicable to, for example, communication between a node different from the ECU and the ECU, and is also applicable to communication between a plurality of nodes different from the ECU.

(3-5) The present disclosure is not limited to application to an in-vehicle communication system based on in-vehicle Ethernet. The present disclosure is also applicable to an in-vehicle communication system configured to perform communication in accordance with a communication standard different from in-vehicle Ethernet.

(3-6) The present disclosure is not limited to application to a four-wheeled vehicle. The present disclosure is applicable to any form of vehicle including, for example, a two-wheeled vehicle.

(3-7) A plurality of functions of one component in the above embodiments may be implemented by a plurality of components, or one function of one component may be implemented by a plurality of components. A plurality of functions of a plurality of components may be implemented by one component, or one function implemented by a plurality of components may be implemented by one component. Some of the configurations of the above embodiments may be omitted. At least some of the configurations of the above embodiments may be added to or replaced with the configurations of other embodiments.

(3-8) In addition to the in-vehicle communication system described above, the present disclosure can be implemented in various forms, such as a node constituting the in-vehicle communication system, a program for causing a computer to function as the in-vehicle communication system, a program for causing a computer to function as the node, a non-transitory tangible recording medium like a semiconductor memory in which any one or both of these programs are recorded, and a method for properly maintaining the activated state of the node in the in-vehicle communication system.

What is claimed is:

1. An in-vehicle communication system comprising:
a first node; and
a second node configured to perform communication with the first node via a first communication line in accordance with a predetermined communication standard,
wherein
the first node includes
an activation section configured to activate the first node in response to occurrence of an activation factor in the first node in a sleep state, the activation factor being not caused by the communication,
a first transmission section configured to transmit an activation request signal to the second node via the first communication line in response to activation of the first node by the activation section, and
a second transmission section configured to transmit the activation request signal to the second node via the first communication line when a transmission condition is satisfied with the second node, the transmission condition corresponding to a condition under which the activation request signal is to be transmitted, and
the second node is configured to be activated upon receiving the activation request signal from the first communication line while the second node is in the sleep state.

2. The in-vehicle communication system according to claim 1, further comprising
a third node configured to mutually perform the communication with the first node via a second communication line,
wherein
the first transmission section of the first node is configured to further transmit the activation request signal to the third node via the second communication line in response to activation of the first node by the activation section,
the second transmission section of the first node is configured to transmit the activation request signal to the third node via the second communication line when the transmission condition is satisfied with the third node, and
the third node is configured to be activated upon receiving the activation request signal from the second communication line while the third node is in the sleep state.

3. The in-vehicle communication system according to claim 1, further comprising
a third node configured to mutually perform the communication with the first node via a second communication line,
wherein
the second node is configured to be able to transmit the activation request signal to the first node via the first communication line,
the activation section of the first node is configured to activate the first node in response to reception of the activation request signal from the second node while the first node is in the sleep state,
the first node further includes
a first transfer section configured to transmit the activation request signal to the third node via the second communication line when activation occurs in response to the activation request signal from the second node, and
a second transfer section configured to transmit the activation request signal to the third node via the second communication line when the transmission condition is satisfied with the third node, and
the third node is configured to be activated upon receiving the activation request signal from the second communication line while the third node is in the sleep state.

4. The in-vehicle communication system according to claim 1, wherein
the transmission condition is satisfied in response to arrival of a transmission timing set to arrive periodically and repeatedly.

5. The in-vehicle communication system according to claim 1, wherein
the first node includes a determination section configured to determine whether a determination target node is in an anomalous communication state in which the communication with the first node fails to be performed normally,
the determination target node includes the second node, and
the transmission condition with the second node is satisfied in response to the determination section determining that the second node is in the anomalous communication state.

6. The in-vehicle communication system according to claim 2, wherein
the first node includes a determination section configured to determine whether a determination target node is in an anomalous communication state in which the communication with the first node fails to be performed normally,
the determination target node includes the second node and the third node,
the transmission condition with the second node is satisfied in response to the determination section determining that the second node is in the anomalous communication state, and
the transmission condition with the third node is satisfied in response to the determination section determining that the third node is in the anomalous communication state.

7. The in-vehicle communication system according to claim 3, wherein
the second node includes a determination section configured to determine whether a determination target node is in an anomalous communication state in which the communication with the first node fails to be performed normally,
the determination target node includes the third node, and
the transmission condition with the third node is satisfied in response to the determination section determining that the third node is in the anomalous communication state.

8. The in-vehicle communication system according to claim 5, wherein
the transmission condition further requires that the activation factor continue to occur in the first node as a requirement for satisfying the transmission condition.

9. The in-vehicle communication system according to claim 7, wherein
the transmission condition further requires that the second node receive an activation request from the first node as a requirement for satisfying the transmission condition.

10. The in-vehicle communication system according to claim 5, wherein
the determination section is configured to
regularly transmit a prescribed command to the determination target node, and
determine that the determination target node is in the anomalous communication state when response data corresponding to the prescribed command fails to be received properly from the determination target node, and
the determination target node is configured to transmit the response data to the first node in response to reception of the prescribed command from the first node.

11. The in-vehicle communication system according to claim 5, wherein
the determination section is configured to
determine whether the first node is in a link-down state that corresponds to a state in which the first node is physically incapable of properly transmitting and receiving an electrical signal to and from the determination target node, and
determine, when the first node is determined to be in the link-down state, that the determination target node is in the anomalous communication state.

12. The in-vehicle communication system according to claim 5, wherein
the determination section is configured to determine that the determination target node is in the anomalous communication state when predetermined data fails to be received from the determination target node continuously for a certain period of time, and
the determination target node is configured to periodically transmit the predetermined data to the first node at a cycle shorter than the certain period of time when the determination target node is activated in response to the activation request signal from the first node.

13. An in-vehicle communication system comprising:
a plurality of networks that include at least a first network and a second network; and
a plurality of nodes that each belong to the first network and/or the second network,
wherein
the plurality of nodes includes
a first node that belongs to the first network and the second network, and
a second node that belongs to the first network and is configured to perform communication with the first node via a first communication line in accordance with a predetermined communication standard,
the first node includes
a first-node first communication section that belongs to the first network, the first-node first communication section being configured to mutually perform the communication corresponding to the first network with another node that belongs to the first network among the plurality of nodes, and
a first-node second communication section that belongs to the second network, the first-node second communication section being configured to mutually perform the communication corresponding to the second network with another node that belongs to the second network among the plurality of nodes,
the second node includes a second-node first communication section that belongs to the first network, the second-node first communication section being configured to mutually perform the communication corresponding to the first network with another node that belongs to the first network among the plurality of nodes,
the first node further includes
an activation section configured to activate the first-node first communication section in response to occurrence of a first activation factor in the first node when the first-node first communication section is in a sleep state, the first activation factor being a factor to activate the first-node first communication section and not caused by the communication,
a first transmission section configured to perform a first activation request process in response to activation of the first-node first communication section by the activation section, the first activation request process (i) being a process of individually transmitting an activation request signal to another node that belongs to the first network among the plurality of nodes, and (ii) including transmission of the activation request signal to the second node via the first communication line, and
a second transmission section configured to transmit the activation request signal to the second node via the first communication line when a transmission condition with the second-node first communication section is satisfied, the transmission condition corresponding to a condition under which the activation request signal is to be transmitted, and
the second-node first communication section is configured to be activated upon receiving the activation request signal from the first communication line while the second-node first communication section is in the sleep state.

14. The in-vehicle communication system according to claim 13, wherein
the second node further includes a second-node second communication section that belongs to the second network, the second-node second communication section being configured to mutually perform the communication corresponding to the second network with another node that belongs to the second network among the plurality of nodes,
in the first node,
the activation section is configured to activate the first-node second communication section in response to occurrence of a second activation factor in the first node while the first-node second communication section is in the sleep state, the second activation factor being a factor to activate the first-node second communication section and not caused by the communication, and
the first transmission section is configured to perform a second activation request process in response to activation of the first-node second communication section by the activation section, the second activation request process (i) being a process of individually transmitting the activation request signal to another node that belongs to the second network among the plurality of nodes, and (ii) including transmission of the activation request signal to the second node via the first communication line,
the second transmission section is configured to transmit the activation request signal to the second node via the first communication line when the transmission condition is satisfied with the second-node second communication section, and
the second-node second communication section is configured to be activated upon receiving the activation request signal from the first communication line while the second-node second communication section is in the sleep state.

15. The in-vehicle communication system according to claim 14, wherein
the plurality of nodes include a third node that belongs to the second network and is configured to mutually perform the communication with the second node via a second communication line,
the third node includes a third node communication section that belongs to the second network, the third node communication section being configured to mutually perform the communication corresponding to the second network with another node that belongs to the second network among the plurality of nodes,
the second node includes a first transfer section configured to transmit the activation request signal to the third node via the second communication line when the second-node second communication section is activated in response to the activation request signal from the first node, and
the third node communication section is configured to be activated upon receiving the activation request signal from the second communication line while the third node communication section is in the sleep state.

16. The in-vehicle communication system according to claim 15, wherein
the second node includes a second transfer section configured to transmit the activation request signal to the third node via the second communication line when the transmission condition is satisfied with the third node.

17. The in-vehicle communication system according to claim 13, wherein
the transmission condition is satisfied in response to arrival of a transmission timing set to arrive periodically and repeatedly.

18. The in-vehicle communication system according to claim 13, wherein
the first node includes a determination section configured to determine, when the first-node first communication section is activated by the activation section, whether a determination target node is in an anomalous communication state in which the communication corresponding to the first-node first communication section and the first network fails to be performed normally,
the determination target node (i) is another node belonging to the first network among the plurality of nodes and (ii) includes the second node, and
the transmission condition with the second-node first communication section is satisfied in response to the determination section determining that the second node is in the anomalous communication state.

19. The in-vehicle communication system according to claim 14, wherein
the first node includes a determination section configured to
(i) determine, when the activation section activates the first-node first communication section, whether a determination target node corresponding to the first-node first communication section is in an anomalous communication state in which the communication corresponding to the first-node first communication section and the first network fails to be performed normally, and
(ii) determine, when the activation section activates the first-node second communication section, whether a determination target node corresponding to the first-node second communication section is in an anomalous communication state in which the communication corresponding to the first-node second communication section and the second network fails to be performed normally,
the determination target node corresponding to the first-node first communication section is another node belonging to the first network among the plurality of nodes and includes the second node,
the determination target node corresponding to the first-node second communication section is another node belonging to the second network among the plurality of nodes and includes the second node,
the transmission condition with the second-node first communication section is satisfied in response to the determination section determining that the second node is in the anomalous communication state in which the communication corresponding to the first-node first communication section and the first network fails to be performed normally, and
the transmission condition with the second-node second communication section is satisfied in response to the determination section determining that the second node is in the anomalous communication state in which the communication corresponding to the first-node second communication section and the second network fails to be performed normally.

20. The in-vehicle communication system according to claim 15, wherein
the second node includes a determination section configured to determine, when the second-node second communication section is activated by the activation section, whether a determination target node is in an anomalous communication state in which the communication corresponding to the second-node second communication section and the second network fails to be performed normally,
the determination target node (i) is another node belonging to the second network among the plurality of nodes and (ii) includes the third node, and
the transmission condition with the third node is satisfied in response to the determination section determining that the third node is in the anomalous communication state.

21. The in-vehicle communication system according to claim 20, wherein
the transmission condition further requires that the second-node second communication section receive an activation request from the first-node second communication section as a requirement for satisfying the transmission condition.

22. The in-vehicle communication system according to claim 18, wherein
the determination section is configured to
regularly transmit a prescribed command to the determination target node, and
determine that the determination target node is in the anomalous communication state in which the communication corresponding to the network fails to be performed normally when a response data corresponding to the network to which the determination target node belongs fails to be received properly from the determination target node with respect to the prescribed command, and
the determination target node is configured to transmit the response data corresponding to the network to which the determination target node belongs in response to reception of the prescribed command corresponding to the network from the first node.

23. The in-vehicle communication system according to claim 18, wherein
the determination section is configured to
determine whether the first node is in a link-down state that corresponds to a state in which the first node is physically incapable of properly transmitting and receiving an electrical signal to and from the determination target node and thereby fails to perform the communication with the determination target node, and
determine, when it is determined that the first node is in the link-down state, that the determination target node is in the anomalous communication state.

24. The in-vehicle communication system according to claim 18, wherein
the determination section is configured to
(i) determine whether predetermined data corresponding to the network to which the determination target node belongs has been received from the determination target node, and
(ii) determine, when the predetermined data fails to be received continuously for a certain period of time, that the determination target node is in the anomalous communication state in which the communication corresponding to the network fails to be performed normally, and
when the determination target node is activated in response to the activation request signal from the first node, the determination target node is configured to periodically transmit the predetermined data to the first node individually for each of the networks to which the determination target node belongs at a cycle shorter than the certain period of time.

25. The in-vehicle communication system according to claim 13, wherein
the first-node first communication section is configured to individually transmit, after being transmitted, first identification information to another node that belongs to the first network among the plurality of nodes, and the first identification information indicates that the communication corresponding to the first network is executed, and
the second-node first communication section is configured to shift back to the sleep state after being transmitted when the first identification information fails to be received.

26. The in-vehicle communication system according to claim 14, wherein
the first-node second communication section is configured to individually transmit, after being transmitted, second identification information to another node that belongs to the second network among the plurality of nodes, and the second identification information indicates that the communication corresponding to the second network is executed, and
the second-node second communication section is configured to shift back to the sleep state after being transmitted when the second identification information fails to be received.

27. The in-vehicle communication system according to claim 15, wherein
the first transfer section includes a transfer circuit configured to transfer the activation request signal received from the first node to the third node, and
the second node includes a transfer circuit control section configured to disable transfer of the activation request signal to the third node by the transfer circuit when the activation request signal is received by the second node.

28. The in-vehicle communication system according to claim 27, wherein
the transfer circuit control section is configured to re-enable the transfer when both the second-node first communication section and the second-node second communication section shift to the sleep state after the transfer is disabled.

29. A communication node, comprising:
a communication circuit (i) connected to a communication line and (ii) configured to transmit and receive data to and from a communication device connected to the communication line via the communication line in accordance with a predetermined communication standard;
an activation section configured to activate the communication node in response to occurrence of an activation factor in the communication node in a sleep state, the activation factor being not caused by a reception operation of the communication circuit;
a first transmission section configured to transmit an activation request signal to the communication device via the communication line in response to activation of the communication node by the activation section; and
a second transmission section configured to transmit the activation request signal to the communication device via the communication line when a transmission condition with the communication device is satisfied, the transmission condition corresponding to a condition under which the activation request signal is to be transmitted,
wherein
the communication device is configured to be activated upon receiving the activation request signal from the communication line while the communication device is in the sleep state.
